(19) United States
(12) Patent Application Publication
(10) Pub. No.: US 2026/0000073 A1
(43) Pub. Date: Jan. 1, 2026

(54) ANTIMICROBIAL COMPOSITIONS WITH LOW CORROSIVITY AND TOXICITY AND THE USE THEREOF

(71) Applicant: ECOLAB USA INC., Saint Paul, MN (US)

(72) Inventors: Junzhong Li, Eagan, MN (US); Derrick Anderson, Vadnais Heights, MN (US); Chris Nagel, Saint Paul, MN (US); Joshua Luedtke, Saint Paul, MN (US); Alyssa Risch, Saint Paul, MN (US); Brian Sholes, Saint Paul, MN (US); Taz Cheritu, Saint Paul, MN (US); Emily Marie Geyen, Woodbury, MN (US)

(21) Appl. No.: 19/252,229

(22) Filed: Jun. 27, 2025

Related U.S. Application Data
(60) Provisional application No. 63/665,652, filed on Jun. 28, 2024.
(60) Provisional application No. 63/787,125, filed on Apr. 11, 2025.

(51) Int. Cl. A01N 33/24; A01N 25/02; A01N 37/00; A01N 59/00; A01P 1/00

(52) U.S. Cl. CPC A01N 33/24; A01N 25/02; A01N 37/00; A01N 59/00; A01P 1/00

(57) ABSTRACT

The disclosure relates to compositions, including ready-to-use spray or wipe compositions, that are non-toxic, non-corrosive, biodegradable acidic antimicrobial compositions that exhibit broad-spectrum antimicrobial efficacy, wherein the compositions comprise an amine oxide, such as an alkyl amine oxide, in combination with an acidulant. Beneficially, the acidic antimicrobial compositions are capable of achieving at least a 3-log microbial reduction within 5 minutes under relatively mild pH conditions. The compositions provide cleaning and sanitizing.

### CROSS REFERENCE TO RELATED APPLICATIONS

This application claims priority under 35 U.S.C. § 119 to provisional patent application U.S. Ser. No. 63/665,652, filed Jun. 28, 2024 and to provisional patent application U.S. Ser. No. 63/787,125, filed Apr. 11, 2025. The provisional patent applications are herein incorporated by reference in their entirety, including without limitation, the specification, claims, and abstract, as well as any figures, tables, appendices, or drawings thereof.

### TECHNICAL FIELD

The disclosure relates generally to compositions, including ready-to-use spray or wipe compositions, that are non-toxic, low corrosive, biodegradable antimicrobial compositions having a wide spectrum antimicrobial efficacy. The compositions provide beneficial cleaning and sanitizing. The antimicrobial compositions comprise an amine oxide, particularly an alkyl ether amine oxide or an alkyl amine oxide together with an acidulant to provide an at least a 3-log microbial reduction in 5 minutes or less in an in vitro assay under relatively mild pH conditions.

### BACKGROUND

Effective antimicrobial compositions are desirable products for a variety of surface applications, including hard surfaces and soft or porous surfaces. Microorganisms can present significant health hazards due to infection or contamination. When microorganisms are present on the surface of a substrate, they can replicate rapidly to form colonies. Sanitizing substances are used to reduce the risk of exposure and dispersion of pathogenic microorganisms found in industrial applications, such as bacteria, viruses, fungi, and other microorganisms.

Yet many antimicrobial compositions have certain defects, such as high corrosivity, malodor, poor stability, high toxicity, poor biodegradability, and inability to provide microbial kill against a broad spectrum of microorganisms. Quaternary ammonium compounds (QACs) are commonly used antimicrobials owing to their broad efficacy and low corrosivity. However, QACs have poor biodegradability, pose a risk of food product adulteration, leave residues on surfaces, and increase risk to water treatment systems and surface water. Other antimicrobial compositions may be disfavored by consumers as they require two-part systems, including various oxidizing chemistries, or they may have air quality concerns that limit use in open environments, such as open plant environments.

There are no known biocides, excluding QACs and oxidizing chemistries that provide antimicrobial efficacy under desired mild pH conditions that are critical to material compatibility.

Accordingly, there is therefore a need to provide non-toxic, low corrosive antimicrobial compositions capable of providing broad spectrum efficacy under mild pH conditions.

There is also a need to provide antimicrobial compositions which are non-oxidizing and/or non-corrosive and/or capable of being used on metal or sensitive surfaces without damage.

There is a still further need to provide antimicrobial compositions which also pose no concern to food safety or adulteration and/or which pose no concern to water sources.

These and other objects, advantages, and features of the present disclosure will become apparent from the following specification taken in conjunction with the claims set forth herein.

### BRIEF SUMMARY

Disclosed herein are methods of providing surface cleaning, sanitizing and/or disinfecting comprising: (a) contacting a surface in need of cleaning, sanitizing and/or disinfecting with an acidic antimicrobial composition comprising: (i) an alkyl amine oxide according to the structure:

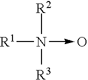

wherein R₁, R₂, and R₃ are independently selected from saturated or unsaturated and straight or branched alkyl groups or aromatic groups having from 1-24 carbons; (ii) an acidulant comprising an inorganic acid, organic acid, or a combination thereof; (iii) optionally a drying agent comprising an alcohol; and (iv) water; (b) wherein the acidic antimicrobial composition achieves at least a 1-log microbial reduction or at least a 3-log microbial reduction in 5 minutes or less in an in vitro assay; wherein the pH of the use solution of the acidic antimicrobial composition is between about 3.5 to about 5.5, or wherein the pH of the RTU acidic antimicrobial composition is between about 4 to about 5.5, or preferably between about 4.5 and about 5.5.

Also disclosed are embodiments, wherein the amine oxide is (a) an alkyl dimethyl amine oxide, (b) an octyl, decyl, dodecyl, isododecyl, or (c) a dimethyl amine oxide that is a lauryl dimethyl amine oxide, myristyl dimethyl amine oxide, palmitic dimethyl amine oxide, or a combination thereof, and/or wherein the acidulant comprises a carboxylic acid, polycarboxylic acid, or a salt thereof, and/or wherein the drying agent comprises methanol, ethanol, propanol, isopropanol, butanol, isobutanol, 2-butoxyethanol, 1-decanol, benzyl alcohol, or combinations thereof, or preferably comprises ethanol, isopropanol or combinations thereof.

Also disclosed are embodiments wherein the amine oxide comprises from about 8 wt-% to about 50 wt-%, or from about 10 wt-% to about 45 wt-% of the composition, and/or wherein the acidulent comprises from about 1 wt-% to about 20 wt-%, or from about 10 wt-% to about 20 wt-% of the composition.

Still further disclosed are embodiments wherein the contacting is wiping a surface with a substrate either saturated with or sprayed with a ready-to-use (RTU) dilution of the acidic antimicrobial composition, and wherein the amine oxide comprises from about 0.01 wt-% to about 10 wt-%, or from about 0.01 wt-% to about 1 wt-%, optionally wherein the drying agent comprises from about 1 wt-% to about 15 wt-%, or from about 1 wt-% to about 10 wt-%, and/or wherein the acidulent comprises from about 0.1 wt-% to about 10 wt-%, or from about 0.1 wt-% to about 5 wt-% of the RTU composition.

Also disclosed are embodiments wherein the acidic antimicrobial composition (a) has at least about 75%, at least about 80%, at least about 85%, or at least about 90% reduction in the concentration of quaternary ammonium compounds, oxidizing chemistries, and/or disinfectants compared to an antimicrobial composition that does not include the alkyl amine oxide and the acidulent; or (b) has less than about 20 wt-%, 10 wt-%, 5 wt-% or 1 wt-% of quaternary ammonium compounds, oxidizing chemistries, and/or disinfectants in the acidic antimicrobial composition; or (c) has less than about 1 wt-%, 0.5 wt-%, 0.1 wt-% of quaternary ammonium compounds, oxidizing chemistries, and/or disinfectants in the RTU of the acidic antimicrobial composition.

Still further disclosed are embodiments wherein the 3-log microbial reduction in 5 minutes or less in an in vitro assay against Klebsiella aerogenes or Staphylococcus aureus for non-food contact surface sanitizing; wherein the method achieves a 5-log microbial reduction in 30 seconds or less in an in vitro assay against Staphylococcus aureus and/or Escherichia coli for food contact surface sanitizing; wherein the method achieves at least a 1-log reduction of a non-pathogenic organism, and/or wherein the method provides disinfection of a treated surface. Various surfaces are described herein as suitable for the methods as described.

Disclosed herein are also concentrate or ready-to-use (RTU) acidic antimicrobial compositions comprising: (i) an alkyl amine oxide according to the structure:

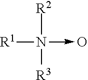

wherein R₁, R₂, and R₃ are independently selected from saturated or unsaturated and straight or branched alkyl groups or aromatic groups having from 1-24 carbons; (ii) an acidulant comprising an inorganic acid, organic acid, or a combination thereof; (iii) optionally a drying agent comprising an alcohol; and (iv) water; wherein the pH of the concentrate composition is between about 3.5 to about 5.5, or wherein the pH of the RTU acidic antimicrobial composition is between about 4 to about 5.5, or preferably from about 4.5 to about 5.5, and wherein the RTU acidic antimicrobial composition is optionally saturated on a wipe substrate.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

FIG. 1 shows a graph of the data from Example 1 demonstrating sanitizing efficacy of the evaluated compositions.

Various embodiments of the present disclosure will be described in detail with reference to the drawings. Reference to various embodiments does not limit the scope of the disclosure. Figures represented herein are not limitations to the various embodiments according to the disclosure and are presented for exemplary illustration of the invention.

### DETAILED DESCRIPTION

The present disclosure relates to compositions that provide effective antimicrobial efficacy, particularly broad spectrum antimicrobial efficacy, and are suitable for application on a variety of surfaces, including hard surfaces and soft or porous surfaces. Also disclosed herein are methods of using the same. It is particularly beneficial that the compositions provide biocidal synergy under mild pH conditions.

The embodiments of this disclosure are not limited to particular types of compositions or methods, which can vary. It is further to be understood that all terminology used herein is to describe particular embodiments only and is not intended to be limiting in any manner or scope. For example, as used in this specification and the appended claims, the singular forms “a,” “an” and “the” can include plural referents unless the context indicates otherwise. Unless indicated otherwise, “or” can mean any one alone or any combination thereof, e.g., “A, B, or C” means the same as any of A alone, B alone, C alone, “A and B,” “A and C,” “B and C” or “A, B, and C.” Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, a description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6, and decimals and fractions, for example, 1.2, 3.8, 1½, and 4¾ This applies regardless of the breadth of the range.

So that the present disclosure may be more readily understood, certain terms are first defined. Unless defined otherwise, all technical and scientific terms used herein have the same meaning as commonly understood by one of ordinary skill in the art to which embodiments of the disclosure pertain. Many methods and materials similar, modified, or equivalent to those described herein can be used in the practice of the embodiments of the present disclosure without undue experimentation, the preferred materials and methods are described herein. In describing and claiming the embodiments of the present disclosure, the following terminology will be used in accordance with the definitions set out below.

The terms “a,” “an,” and “the” include both singular and plural referents.

The term “or” is synonymous with “and/or” and means any one member or combination of members of a particular list.

The term “about,” as used herein, refers to variation in the numerical quantity that can occur, for example, through typical measuring techniques and equipment, with respect to any quantifiable variable, including, but not limited to, mass, volume, time, temperature, pH, reflectance, whiteness, etc. Further, given solid and liquid handling procedures used in the real world, there is certain inadvertent error and variation that is likely through differences in the manufacture, source, or purity of the ingredients used to make the compositions or carry out the methods and the like. The term “about” also encompasses amounts that differ due to different equilibrium conditions for a composition resulting from a particular initial mixture. The term “about” also encompasses these variations. Whether or not modified by the term “about,” the claims include equivalents to the quantities.

The term “actives” or “percent actives” or “percent by weight actives” or “actives concentration” are used interchangeably herein and refer to the concentration of those ingredients involved in cleaning expressed as a percentage minus inert ingredients such as water or salts.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

Alkenyl groups or alkenes are straight chain, branched, or cyclic alkyl groups having two to about 30 carbon atoms, and further including at least one double bond. In some embodiments, an alkenyl group has from 2 to about 30 carbon atoms, or typically, from 2 to 10 carbon atoms. Alkenyl groups may be substituted or unsubstituted. For a double bond in an alkenyl group, the configuration for the double bond can be a trans or cis configuration. Alkenyl groups may be substituted similarly to alkyl groups.

Alkynyl groups are straight chain, branched, or cyclic alkyl groups having two to about 30 carbon atoms, and further including at least one triple bond. In some embodiments, an alkynyl group has from 2 to about 30 carbon atoms, or typically, from 2 to 10 carbon atoms. Alkynyl groups may be substituted or unsubstituted. Alkynyl groups may be substituted similarly to alkyl or alkenyl groups.

As used herein, the terms “alkylene”, “cycloalkylene”, “alkynylides”, and “alkenylene”, alone or as part of another substituent, refer to a divalent radical derived from an alkyl, cycloalkyl, or alkenyl group, respectively, as exemplified by —CH₂CH₂CH₂—. For alkylene, cycloalkylene, alkynylene, and alkenylene groups, no orientation of the linking group is implied.

The term “alcohol” as used herein refers to —ROH groups. R is absent, a substituted or unsubstituted alkylene, cycloalkylene, alkenylene, alkynylene, arylene, aralkylene, heterocyclylalkylene, or heterocyclylene group as defined herein.

The term “amine” (or “amino”) as used herein refers to —RNR¹R² groups. R is absent, a substituted or unsubstituted alkylene, cycloalkylene, alkenylene, alkynylene, arylene, aralkylene, heterocyclylalkylene, or heterocyclylene group as defined herein. R¹ and R² are independently hydrogen, or a substituted or unsubstituted alkyl, cycloalkyl, alkenyl, alkynyl, aryl, aralkyl, heterocyclylalkyl, or heterocyclyl group as defined herein.

The term “carboxylic acid” as used herein refers to —RCOOH groups. R is absent, a substituted or unsubstituted alkylene, cycloalkylene, alkenylene, alkynylene, arylene, aralkylene, heterocyclylalkylene, or heterocyclylene group as defined herein.

As used herein, the term “corrosive” refers to an agent or composition that results in chemical attack, oxidation, discoloration, dimensional changes and/or weight loss of a surface and/or pitting of a surface. Various mechanisms of corrosion are disclosed in Corrosion Basics, National Association of Corrosion Engineers, 1984, including for example, metal corrosion through a redox attack, attacking and penetrating the passivation layers of metal, pitting of surfaces, etc. Compositions that are non-corrosive beneficially do not cause or exhibit any chemical attack, oxidation, discoloration, dimensional and/or weight loss of a surface and/or pitting of a surface. Exemplary methodology for assessing corrosive or non-corrosive properties of a composition can include weight assessment to measure surface changes and/or gloss measurements.

As used herein, the term “disinfectant” refers to an agent that kills all vegetative cells including most recognized pathogenic microorganisms. In an embodiment, a disinfectant according to U.S. standards can use the procedure described in A.O.A.C. Use Dilution Methods, Official Methods of Analysis of the Association of Official Analytical Chemists, paragraph 955.14 and applicable sections, 15th Edition, 1990 (EPA Guideline 91-2). As used herein, the term “high level disinfection” or “high level disinfectant” refers to a compound or composition that kills substantially all organisms, except high levels of bacterial spores, and is affected with a chemical germicide cleared for marketing as a sterilant by the Food and Drug Administration. As used herein, the term “intermediate-level disinfection” or “intermediate level disinfectant” refers to a compound or composition that kills mycobacteria, most viruses, and bacteria with a chemical germicide registered as a tuberculocide by the Environmental Protection Agency (EPA). As used herein, the term “low-level disinfection” or “low level disinfectant” refers to a compound or composition that kills some viruses and bacteria with a chemical germicide registered as a hospital disinfectant by the EPA.

In an embodiment, a disinfectant according to EU standards is as set forth in DIRECTIVE 98/8/EC OF THE EUROPEAN PARLIAMENT AND OF THE COUNCIL of 16 Feb. 1998, and Guidance on the Biocidal Products Regulation Volume II Efficacy—Assessment and Evaluation (Parts B+C) Version 3.0 April 2018—ECHA (European Chemicals Agency), each of which are herein incorporated by reference in their entirety.

A disinfectant can include any one of four groups of biocidal products with five defined product types for products that reduces the number of microorganisms in or on an inanimate matrix-achieved by the irreversible action of a product. In an embodiment, the disinfectant products can be confirmed using a variety of recognized testing methods (CEN, OECD, ISO, etc.); see Guidance document, Appendices 2 and 4. According to various embodiments of the methods and compositions described herein, the EN1276 methodology was used to demonstrate bactericidal performance with a 5 log reduction requirement and the EN14476 methodology was used to demonstrate viricidal performance with a 4 log reduction requirement.

The term “ester” as used herein refers to —RCOOR¹ group. R is absent, a substituted or unsubstituted alkylene, cycloalkylene, alkenylene, alkynylene, arylene, aralkylene, heterocyclylalkylene, or heterocyclylene group as defined herein. R¹ is a substituted or unsubstituted alkyl, cycloalkyl, alkenyl, alkynyl, aryl, aralkyl, heterocyclylalkyl, or heterocyclyl group as defined herein.

The term “ether” as used herein refers to —ROR, —ROAr, or ArOAr groups, wherein R is an alky group and Ar represents an aryl group.

As used herein, the phrase “food processing surface” refers to a surface of a tool, a machine, equipment, a structure, a building, or the like that is employed as part of a food or beverage processing, preparation, or storage activity. Food processing surface is intended to encompass all surfaces used in brewing (including beer brewing and preparation of liquors and spirits) and winemaking processes (e.g., bright beer tanks and lines, fermentation vessels, mash tuns, bottling equipment, pipes, and storage vessels). Examples of food processing surfaces include surfaces of food processing or preparation equipment (e.g., boiling, fermenting, slicing, canning, or transport equipment, including flumes), of food processing wares (e.g., utensils, dishware, wash ware, and bar glasses), and of floors, walls, or fixtures of structures in which food processing occurs. Food processing surfaces are found and employed in food anti-spoilage air circulation systems, aseptic packaging sanitizing, food refrigeration and cooler cleaners and sanitizers, ware washing sanitizing, blancher cleaning and sanitizing, food packaging materials, cutting board additives, third-sink sanitizing, beverage chillers and warmers, meat chilling or scalding waters, autodish sanitizers, sanitizing gels, cooling towers, food processing antimicrobial garment sprays, and non-to-low-aqueous food preparation lubricants, oils, and rinse additives.

As used herein, the phrase “food product” includes any food substance that might require treatment with an antimicrobial agent or composition and that is edible with or without further preparation. Food products include meat (e.g. red meat and pork), seafood, poultry, produce (e.g., fruits and vegetables), eggs, living eggs, egg products, ready to eat food, wheat, seeds, roots, tubers, leafs, stems, corns, flowers, sprouts, seasonings, or a combination thereof. The term “produce” refers to food products such as fruits and vegetables and plants or plant-derived materials that are typically sold uncooked and, often, unpackaged, and that can sometimes be eaten raw.

The term “GSM” refers to the basis weight of a wipe composition measured in grams per square meter (gram/m²). Most commercially available wipe compositions have between about 20-100 GSM, or more often <40 GSM for synthetic substrates and >40 GSM for cellulose substrates, with variation between vendors expected.

The term “hard surface” refers to a solid, substantially non-flexible surface such as a counter top, tile, floor, wall, panel, window, plumbing fixture, kitchen and bathroom furniture, appliance, engine, circuit board, and dish. Hard surfaces may include for example, health care surfaces and food processing surfaces.

As used herein, the phrase “health care surface” refers to a surface of an instrument, a device, a cart, a cage, furniture, a structure, a building, or the like that is employed as part of a health care activity. Examples of health care surfaces include surfaces of medical or dental instruments, of medical or dental devices, of electronic apparatus employed for monitoring patient health, and of floors, walls, or fixtures of structures in which health care occurs. Health care surfaces are found in a hospital, surgical, infirmity, birthing, mortuary, and clinical diagnosis room. These surfaces can be those typified as “hard surfaces” (such as walls, floors, bedpans, etc.,), or fabric surfaces, e.g., knit, woven, and non-woven surfaces (such as surgical garments, draperies, bed linens, bandages, etc.,), or patient-care equipment (such as respirators, diagnostic equipment, shunts, body scopes, wheel chairs, beds, etc.,), or surgical and diagnostic equipment. Health care surfaces include articles and surfaces employed in animal health care.

As used herein, the term “instrument” refers to the various medical or dental instruments or devices that can benefit from cleaning with a composition according to the present invention. As used herein, the phrases “medical instrument,” “dental instrument,” “medical device,” “dental device,” “medical equipment,” or “dental equipment” refer to instruments, devices, tools, appliances, apparatus, and equipment used in medicine or dentistry. Such instruments, devices, and equipment can be cold sterilized, soaked or washed and then heat sterilized, or otherwise benefit from cleaning in a composition of the present invention. These various instruments, devices and equipment include, but are not limited to: diagnostic instruments, trays, pans, holders, racks, forceps, scissors, shears, saws (e.g. bone saws and their blades), hemostats, knives, chisels, rongeurs, files, nippers, drills, drill bits, rasps, burrs, spreaders, breakers, elevators, clamps, needle holders, carriers, clips, hooks, gouges, curettes, retractors, straightener, punches, extractors, scoops, keratomes, spatulas, expressors, trocars, dilators, cages, glassware, tubing, catheters, cannulas, plugs, stents, scopes (e.g., endoscopes, stethoscopes, and arthoscopes) and related equipment, and the like, or combinations thereof.

As used herein, the term “laundry” refers to items or articles that are cleaned in a laundry washing machine. In general, laundry refers to any item or article made from or including textile materials, woven fabrics, non-woven fabrics, and knitted fabrics. The textile materials can include natural or synthetic fibers such as silk fibers, linen fibers, cotton fibers, polyester fibers, polyamide fibers such as nylon, acrylic fibers, acetate fibers, and blends thereof including cotton and polyester blends. The fibers can be treated or untreated. Exemplary treated fibers include those treated for flame retardancy. It should be understood that the term “linen” is often used to describe certain types of laundry items including bed sheets, pillow cases, towels, table linen, table cloth, bar mops and uniforms.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

As used herein, the term “sanitizer” refers to an agent that reduces the number of bacterial contaminants to safe levels as judged by public health requirements. In an embodiment, sanitizers for use in this invention will provide at least a 3-log reduction and more preferably a 5-log order reduction. These reductions can be evaluated using a procedure set out in Germicidal and Detergent Sanitizing Action of Disinfectants, Official Methods of Analysis of the Association of Official Analytical Chemists, paragraph 960.09 and applicable sections, 15th Edition, 1990 (EPA Guideline 91-2). According to this reference a sanitizer should provide a 99.999% reduction (5-log order reduction) within 30 seconds at room temperature, 25±2° C., against several test organisms.

As used herein, the term “soil” refers to polar or non-polar organic or inorganic substances including, but not limited to carbohydrates, proteins, fats, oils, and the like which may or may not contain particulate matter such as mineral clays, sand, natural mineral matter, carbon black, graphite, kaolin, environmental dust, colorant, dyes, polymers, and oils. These substances may be present in their organic state or complexed to a metal to form an inorganic complex. The terms “soil” and “stain” include, but are not limited to, oil-based stains.

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

As used herein, “substituted” refers to an organic group as defined below (e.g., an alkyl group) in which one or more bonds to a hydrogen atom contained therein are replaced by a bond to non-hydrogen or non-carbon atoms. Substituted groups also include groups in which one or more bonds to carbon(s) or hydrogen(s) atoms are replaced by one or more bonds, including double or triple bonds, to a heteroatom. Thus, a substituted group is substituted with one or more substituents, unless otherwise specified. A substituted group can be substituted with 1, 2, 3, 4, 5, or 6 substituents. Substituted ring groups include rings and ring systems in which a bond to a hydrogen atom is replaced with a bond to a carbon atom. Therefore, substituted cycloalkyl, aryl, heterocyclic, and heteroaryl groups may also be substituted with substituted or unsubstituted alkyl, alkenyl, and alkynyl groups are defined herein.

As used herein the terms “use solution,” “ready to use,” or variations thereof refer to a composition that is diluted, for example, with water, to form a use composition having the desired components of active ingredients for cleaning. For reasons of economics, a concentrate can be marketed, and an end-user can dilute the concentrate with water or an aqueous diluent to a use solution.

As used herein, the term “virucidal” refers to an agent that reduces the number of viruses on a surface or substrate. In an embodiment, virucidal compositions will provide at least a 3-log order reduction, or preferably a 5-log order reduction, or more preferably a complete inactivation of viruses. These reductions can be evaluated using a procedure set out in ASTM E1053 Standard Test Method for Efficacy of Virucidal Agents Intended for Inanimate Environmental Surfaces; US standards are set forth in EPA 810.2200; EP standards are set forth in EN 14476, each of which are herein incorporated by reference in its entirety. The outlined log reductions can be achieved over various periods of time (which can vary according to contact time requirements set forth in various jurisdictions), including for example less than about 60 minutes, less than about 30 minutes, less than about 5 minutes, less than 1 minute, less than about 30 seconds, or even less than about 15 seconds. According to this reference a virucidal composition should provide a 99.9% reduction (3-log order reduction) for virucidal activity.

As used herein, the term “water” for treatment according to the invention includes a variety of sources, such as freshwater, pond water, sea water, salt water or brine source, brackish water, recycled water, wastewater, or the like. Waters are also understood to optionally include both fresh and recycled water sources (e.g. “produced waters”), as well as any combination of waters for treatment according to the invention. In some embodiments, produced water (or reuse water) refers to a mixture of water that comprises both water recycled from previous or concurrent oil- and gas-field operations, e.g., fracking, and water that has not been used in oil- and gas-field operations, e.g., fresh water, pond water, sea water, etc.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

As used herein, the term “free,” “no,” “substantially no” or “substantially free” refers to a composition, mixture, or ingredient that does not contain a particular compound or to which a particular compound or a particular compound-containing compound has not been added. In some embodiments, the reduction and/or elimination of hydrogen peroxide according to embodiments provide hydrogen peroxide-free or substantially-free compositions. Should the particular compound be present through contamination and/or use in a minimal amount of a composition, mixture, or ingredients, the amount of the compound shall be less than about 3 wt-%. More preferably, the amount of the compound is less than 2 wt-%, less than 1 wt-%, and most preferably the amount of the compound is less than 0.5 wt-%.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The methods and compositions disclosed herein may comprise, consist essentially of, or consist of the components and ingredients described herein as well as other ingredients not described herein. As used herein, “consisting essentially of” means that the methods and compositions may include additional steps, components or ingredients, but only if the additional steps, components or ingredients do not materially alter the basic and novel characteristics of the claimed methods and compositions.

It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

The “scope” of the present disclosure is defined by the claims, along with the full scope of equivalents to which such claims are entitled. The scope of the disclosure is further qualified as including any possible modification to any of the aspects and/or embodiments disclosed herein which would result in other embodiments, combinations, sub-combinations, or the like that would be obvious to those skilled in the art.

### Compositions

Exemplary ranges of the compositions are shown in Table 1A below in weight percentage of the compositions and Table 1B for RTU compositions.

TABLE 1A

| | Example | Example | Example |
|---|---|---|---|
| | Embodiment | Embodiment | Embodiment |
| Component | 1 (wt-%) | 2 (wt-%) | 3 (wt-%) |
| Amine Oxide | 5-70 | 8-50 | 10-45 |
| Acidulant(s) | 1-30 | 1-20 | 10-20 |
| Additional Functional | Remainder | Remainder | Remainder |
| Ingredients | | | |
| Total | 100 | 100 | 100 |

TABLE 1B

| | Example | Example | Example |
|---|---|---|---|
| | Embodiment | Embodiment | Embodiment |
| Component | 1 (wt-%) | 2 (wt-%) | 3 (wt-%) |
| Amine Oxide | 0.01-10 | 0.01-1 | 0.01-0.2 |
| Water | 50-95 | 60-95 | 70-95 |
| Acidulant(s) | 0.1-10 | 0.1-5 | 0.1-2 |
| Additional Functional | Remainder | Remainder | Remainder |
| Ingredients | | | |
| Optionally Drying Agent | 0-15 | 1-15 | 1-10 |
| Total | 100 | 100 | 100 |

The compositions can be provided in a liquid concentrate form. The liquid concentrate compositions may be diluted to form a use solution. Alternatively, the compositions may be provided in a ready-to-use (RTU) liquid, also referred to as a use solution or a use liquid, wherein the compositions are ready to be applied to a surface. The compositions disclosed herein may be used in any part of the wash cycle, but preferably during a wash phase, a rinse phase, or as a pre-soak.

In embodiments with a wipe composition that contacts a surface or article, it is beneficial that a RTU composition is provided. It should be understood that the concentration of the amine oxide, acidulants, and other components of the compositions will vary depending on whether the composition is provided as a concentrate or as a use solution. One skilled in the art can adjust % by weight of the compositions to arrive at a composition having a different dilution rate, which is within the scope of the disclosed compositions.

A use solution may be prepared from the concentrate compositions by diluting the composition with water or other diluent (e.g., by contacting with a water source) at a dilution ratio that provides a use solution having desired detersive properties. The typical dilution factor is between approximately 1 and approximately 10,000 but will depend on factors including water hardness, the amount of soil to be removed, and the like. In an embodiment, the composition is diluted at a ratio of between about 1:10 and about 1:10,000 composition to water, inclusive of all integers with this range, e.g., 1:50, 1:100, 1:1,000, and the like. Particularly, the composition is diluted at a ratio of between about 1:10 and about 1:5,000 concentrate to diluent, or between about 1:10 and about 1:1,000 concentrate to diluent.

Beneficially, the compositions herein provide wide spectrum antimicrobial efficacy at a pH range of between about 3.5 to about 5.5. In particular, the pH of a use solution diluted from the acidic antimicrobial composition is between about 3.5 to about 5.5, between about 4 to about 5.5, or preferably between about 4 and about 5, e.g., between about 3.5 and about 4.0, 4.0 and 4.5, 4.5 and 5.0, or 5.0 and 5.5.

As a further benefit, according to embodiments, the acidic antimicrobial composition has at least about 75%, at least about 80%, at least about 85%, or at least about 90% reduction in the concentration of quaternary ammonium compounds, anionic surfactants, oxidizing chemistries, and/or disinfectants compared to an antimicrobial composition that does not include the alkyl amine oxide and the acidulent.

According to still further embodiments, the acidic antimicrobial composition has less than about 20 wt-%, 10 wt-%, 5 wt-%, or 1 wt-% of quaternary ammonium compounds, anionic surfactants, oxidizing chemistries, and/or disinfectants in the acidic antimicrobial composition compared to an antimicrobial composition that does not include the alkyl amine oxide and the acidulent. In RTU compositions, the acidic antimicrobial composition has less than about 1 wt-%, 0.5 wt-%, or 0.1 wt-% of quaternary ammonium compounds, anionic surfactants, oxidizing chemistries, and/or disinfectants in the acidic antimicrobial composition compared to an antimicrobial composition that does not include the alkyl amine oxide and the acidulent.

In preferred embodiments the composition (either concentrate or RTU) is substantially free of (or free of) quaternary ammonium compounds, anionic surfactants, oxidizing chemistries, disinfectants, and/or N-alkylpyrrolidones or derivatives thereof.

### Acidulant

In an embodiment, the compositions include one or more acidulants. The term “acidulant” generally refers to an acidifying agent or an acid. Suitable types of acidulants include but are not limited to an organic acid, inorganic acid, or a combination thereof.

In an embodiment, the compositions include one or more organic acids, preferably a C₁-C₁₈ organic acid and still more preferably a C₂-C₆ organic acid. An organic acid is an organic compound characterized by having a hydrogen atom that can be released as a proton. Organic acids are typically considered weak acids, when compared to most inorganic acids, and can be classified according to their functional group. Organic acids can contain one or more of a hydroxyl group (—OH), carboxyl group (—COOH), and a sulfo group (—S(═O)₂—OH). In other words, organic acids can include, without limitation, alcohols, carboxylic acids, and sulfonic acids.

Example organic acids suitable for use in the compositions include carboxylic acids, such as alpha hydroxycarboxylic acids. Suitable carboxylic acids include, without limitation, lactic acid, citric acid, acetic acid, formic acid, oxalic acid, uric acid, malic acid, tartaric acid, gluconic acid, glucaric acid, ascorbic acid, glutamic acid, levulinic acid, heptanoic acid, octanoic acid, nonanoic acid, decanoic acid, dodecanoic acid, tetradecanoic acid, hexadecenoic acid, octadecanoic acid, benzoic acid, icosanoic acid, azelaic acid, or a combination thereof. In a preferred embodiment, the carboxylic acid is a C₂-C₉ carboxylic acid, or a salt or a combination thereof.

Examples of suitable sulfonic acids include, without limitation, benzene sulfonic acid, naphthalene sulfonic acid, perfluoro sulfonic acid, or a combination thereof. Salts of sulfonic acids (sulfonates) are also suitable. More particularly, suitable sulfonic acids include aliphatic sulfonic acids, aromatic sulfonic acids, methanesulfonic acid, ethanedisulfonic acid, 2-ethanesulfonic acid, 2-aminoethanesulfonic acid, toluenesulfonic acid, sodium tetradecyl sulfate, 2-Acrylamido-2-methylpropane sulfonic acid (AMPS), or a combination thereof. In a preferred embodiment, the organic comprises lactic acid, tartaric acid, or a salt or a combination thereof.

In an embodiment, the compositions additionally or alternatively include one or more inorganic acids. Suitable inorganic acids include but are not limited to hydrochloric acid, sulfuric acid, sulfamic acid, phosphonic acid, nitric acid, phosphoric acid, pyrophosphoric acid, phosphorous acid, hydrofluoric acid, boric acid, perchloric acid, or a combination thereof.

Preferably the one or more acidulants do not adversely affect the surface to be cleaned or sanitized, e.g., corrosion of a hard surface or irritation or degradation of a soft surface.

The one or more acidulants may be present in an amount of between about 1 wt-% to about 30 wt %, about 1 wt-% to about 20 wt %, or about 10 wt-% to about 20 wt %, including about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, and 30% by weight.

The one or more acidulants may be present in the RTU composition in an amount of between about 0.1 wt-% to about 10 wt %, about 0.1 wt-% to about 5 wt %, or about 0.1 wt-% to about 2 wt %.

### Amine Oxide

In an embodiment, the compositions include one or more amine oxides. Amine oxides are generally nonionic surfactant under neutral or alkaline pHs, that can also behave as cationic surfactants under acidic conditions, as they are surface active agents composed of tertiary amine. Amine oxides are generally classified as amphoteric surfactants because they can exhibit both nonionic and cationic properties depending on the pH of the solution. In an embodiment, the amine oxide can be employed in food products or for cleaning or sanitizing food processing equipment or materials. In an embodiment, the amine oxide can be employed in a health-care environment. In an embodiment, the amine oxide can be employed in a textile, agricultural, or farm environment. In an embodiment, the amine oxide is non-toxic. In an embodiment, the amine oxide can be employed according to guidelines from government agencies, such as the U.S. Food and Drug Administration, without adverse labeling requirements.

Examples of suitable amine oxides include but are not limited to those having a general structure:

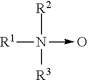

wherein R₁, R₂, and R₃ are independently selected from saturated or unsaturated and straight or branched alkyl groups having from 1-24 carbons and aromatic groups, etc. and which can optionally contain O, N or P as a heteroatom or polyalkoxy groups.

In an embodiment, R₁ is an alkyl group having 4-18 carbons and R₂ and R₃ are alkyl groups having 1-18 carbons. In an embodiment, R₁ is an alkyl group having 6-10 carbons and R₂ and R₃ are alkyl groups having 1-2 carbons.

In an embodiment, R₁ is an alkyl group having 8 carbon atoms and R₂ and R₃ are alkyl groups having 1-2 carbon atoms. In an embodiment, R₁ is an alkyl group having 12 carbons and R₂ and R₃ are alkyl groups having 1-2 carbons.

In preferred embodiments the amine oxides according to the acidic antimicrobial compositions are alkyl amine oxide according to the structure:

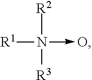

wherein R¹ is an alkyl group from >C8 and ≤C16 or a blend thereof; R² and R³ are alkyl or hydroxyalkyl of C₁-C₃ or a mixture thereof.

In a further preferred embodiment the amine oxides are alkyl dimethyl amine oxides wherein R¹ is an alkyl group from >C8 and ≤C16, and both R² and R³ are methyl (CH₃).

Examples of amine oxides include, but are not limited to alkyl dimethyl amine oxide, dialkyl methyl amine oxide, alkyl dialkoxyamine oxide, dialkyl alkoxyamine oxide, dialkyl etheramine oxide and dialkoxyetheramine oxide, octyldimethylamine oxide, myristyldimethylamine oxide, didecylmethylamine oxide, methylmorpholine oxide, tetradecyldiethoxyamine oxide, and lauryldimethylamine oxide. Particularly suitable amine oxides include octyldimethylamine oxide, dodecyldimethyl amine oxide, lauryldimethylamine oxide, cocoamine oxide, a C10-C16 amine oxide or a blend thereof. Particularly preferred amine oxides include a blend of lauric, myristic, palmitic, octyl, decyl, and oleyl amine oxides, or a blend thereof. Such a blend of amine oxides may be obtained commercially as Barlox 12.

Additional blends of amine oxides having alkyl groups from ≥C12 and ≤C16 or a blend thereof include Barlox 12 (available from Lonza), Ammonyx LO (available from Stepan), Ammonyx LO Special (available from Stepan), Neominox LA 4230 (available from Oxiteno), Mackamine LA (available from Solvay), and Mackamine LA EF (available from Solvay).

The one or more amine oxides may be present in an amount of between about 5 wt-% to about 70 wt %, about 8 wt-% to about 50 wt %, or about 10 wt-% to about 45 wt %, including about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, and 70% by weight.

The one or more amine oxides may be present in the RTU composition in an amount of between about 0.01 wt-% to about 10 wt %, about 0.01 wt-% to about 1 wt %, or about 0.01 wt-% to about 0.2 wt %. It is beneficial that the amine oxides can provide efficacy in the RTU composition at concentrations of at least about 100 ppm, or in other embodiments of at least about 200 ppm.

### Additional Surfactants

The compositions optionally include one or more additional surfactants beyond the amine oxide(s) described herein. Suitable types of surfactants include, but are not limited to, anionic surfactants, zwitterionic surfactants, semi-polar nonionic surfactants, nonionic surfactants, and/or cationic surfactants. In an embodiment, the compositions are free of cationic surfactants such as quaternary ammonium compounds. In another embodiment, the compositions may include biocides. Suitable biocides include, but are not limited to C5 to C18 fatty acids, alpha-hydroxycarboxylic acids, hydrogen peroxide, peroxycarboxylic acids, sodium hypochlorite, iodine.

### Anionic Surfactants

Anionic surfactants are surface-active substances that are categorized as anionics because the charge on the hydrophobe is negative, or they are anionic surfactants in which the hydrophobic section of the molecule carries no charge unless the pH is elevated to neutrality or above (e.g., carboxylic acids). Carboxylate, sulfonate, sulfate, sulfolaurate, and phosphate are the polar (hydrophilic) solubilizing groups found in anionic surfactants. Of the cations (counter ions) associated with these polar groups, sodium, lithium, and potassium impart water solubility; ammonium and substituted ammonium ions provide both water and oil solubility; and calcium, barium, and magnesium promote oil solubility. In a preferred embodiment, the compositions include at least one anionic sulfonate surfactant.

In some embodiments the use of an anionic surfactant in combination with the amine oxide surfactant presents a challenge in formulation and stability of compositions as this combination can lead to precipitation.

The at least one anionic surfactant disclosed herein can be an anionic surfactant comprising at least one or more sulfate functional group (—OSO₃H or —OSO₃⁻) or at least one sulfonate functional group (—SO₃H or —SO₃⁻), respectively.

Anionic sulfonate surfactants suitable for use in the present compositions include alkyl sulfonates, the linear and branched primary and secondary alkyl sulfonates, the aromatic sulfonates with or without substituents, and alkyl sulfolaurates. More particularly, examples of suitable anionic sulfonate surfactants include, without limitation, benzene sulfonates such as sodium dodecyl benzene sulfonate (SDBS), alkyl sulfonates, alkylamide sulfonates, alkylaryl sulfonates, α-olefin sulfonates, paraffin sulfonates, alkyl sulfosuccinates, alkyl ether sulfosuccinates, alkylamide sulfosuccinates, alkyl sulfoacetates, alkyl sulfosuccinamates, acyl isethionates, and N-acyltaurates. In an embodiment, the alkyl and acyl groups of these compounds preferably comprise from 14 to 30 carbon atoms, or from 16 to 22 carbon atoms. In an embodiment, the aryl group comprises a phenyl or benzyl group. The sulfonates may be optionally oxyethylenated and comprise from 1 to 50 ethylene oxide units.

Anionic sulfate surfactants suitable for use in the present compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like, including sodium lauryl sulfate (SLS also available as SULFOPON® 101 UP) and sodium laureth sulfate (SLES, also referred to as sodium lauryl ether sulfate). Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule).

Also included are sulfolaurate anionic surfactants. Examples of suitable sulfolaurate anionic surfactants include, without limitation, alkyl sulfolaurates and salts thereof. Preferred sulfolaurates include sodium methyl 2-sulfolaurate, disodium 2-sulfolaurate, or a combination thereof.

Anionic carboxylate surfactants suitable for use in the present compositions include carboxylic acids (and salts), such as alkanoic acids (and alkanoates), ester carboxylic acids (e.g., alkyl succinates), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g., alkyl carboxyls). Secondary carboxylates useful in the present compositions include those which contain a carboxyl unit connected to a secondary carbon. The secondary carbon can be in a ring structure, e.g., as in p-octyl benzoic acid, or as in alkyl-substituted cyclohexyl carboxylates.

The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g., N-acyl sarcosinates), taurates (e.g., N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3) in which R is a C₈ to C₂₂ alkyl group or

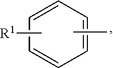

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1.

In other embodiments, R is

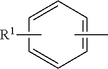

and R¹ is a C₆-C₁₂ alkyl group. In still yet other embodiments, R¹ is a C₉ alkyl group, n is 10 and m is 1.

Such alkyl and alkylaryl ethoxy carboxylates are commercially available. These ethoxy carboxylates are typically available as the acid forms, which can be readily converted to the anionic or salt form. Commercially available carboxylates include Neodox 23-4, a C₁₂₋₁₃ alkyl polyethoxy (4) carboxylic acid (Shell Chemical), and Emcol CNP-110, a C₉ alkylaryl polyethoxy (10) carboxylic acid (Witco Chemical). Carboxylates are also available from Clariant, e.g., the product Sandopan® DTC, a C₁₃ alkyl polyethoxy (7) carboxylic acid.

When present, the compositions include one or more anionic surfactants in an amount of between about 0 wt-% to about 30 wt-%, more preferably between about 1 wt-% and about 15 wt-%, and still more preferably between about 1 wt-% and about 5 wt-%. In a most preferred embodiment, anionic surfactants are not included in the compositions.

In an RTU the one or more anionic surfactants can be present in an amount of between about 0 wt-% to about 5 wt-%, more preferably between about 0.01 wt-% and about 3 wt-%, and still more preferably between about 0.01 wt-% and about 1 wt-%. In a most preferred embodiment, anionic surfactants are not included in the compositions.

### Amphoteric Surfactants

The compositions of the disclosure optionally include one or more amphoteric surfactants. Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic group may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” COSMETICS & TOILETRIES, Vol. 104 (2) 69-71 (1989), which is herein incorporated by reference in its entirety. The first class includes acyl/dialkyl ethylenediamine derivatives (e.g., 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives having application in the present disclosure generally have the general formula: (mono)acetate (di)propionate

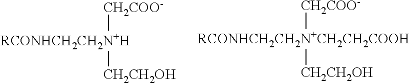

### Neutral pH Zwitterion

### Amphoteric Sulfonate

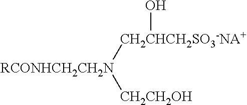

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. A particularly suitable amphoteric is disodium cocoamphodipropionate, commercially available as Mackam 2CSF. Amphocarboxylic acids can be produced from fatty imidazolines in which the dicarboxylic acid functionality of the amphodicarboxylic acid is diacetic acid or dipropionic acid.

The carboxymethylated compounds (glycinates) described herein above frequently are called betaines. Examples of suitable betaines include long-chain betaine amphoteric surfactants. More particularly, suitable betaines include, without limitation, cocamidopropyl betaine (CAPB)/coconut alkyl amidopropyl dimethyl betaine, hexadecyl dimethyl betaine, C₁₂₋₁₄ acylamidopropylbetaine, C₈₋₁₄ acylamidohexyldiethyl betaine, C₁₄₋₁₆ acylmethylamidodiethylammonio-1-carboxybutane, C₁₆₋₁₈ acylamidodimethylbetaine, C₁₂₋₁₆ acylamidopentanediethylbetaine, C₁₂₋₁₆ acylmethylamidodimethylbetaine, or a combination thereof. In a preferred embodiment, the compositions comprise an amphoteric surfactant comprising cocamidopropyl betaine.

Long chain N-alkylamino acids are readily prepared by reaction RNH₂, in which R=C₈-C₁₈ straight or branched chain alkyl, fatty amines with halogenated carboxylic acids.

Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having application in this disclosure include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N+(CH₂—CH₂—CO₂Na)₂—CH₂—CH₂—OH or C₁₂-alkyl-C(O)—N(H)—CH₂—CH₂—N+(CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated by reference in their entirety.

When present in the compositions, the one or more amphoteric surfactants may be present in an amount of between about 0 wt-% to about 15 wt-%, preferably between about 0.1 wt-% and 10 wt-%, still more preferably between about 0.5 wt-% and 2 wt-%. In an embodiment, the compositions are free of amphoteric surfactants.

In an RTU the one or more amphoteric surfactants can be present in an amount of between about 0 wt-% to about 5 wt-%, more preferably between about 0.01 wt-% and about 3 wt-%, and still more preferably between about 0.01 wt-% and about 1 wt-%.

### Nonionic Surfactants

In an embodiment, the compositions optionally include one or more nonionic surfactants. Nonionic surfactants are surfactants typically characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water-soluble compound having the desired degree of balance between hydrophilic and hydrophobic properties.

Useful nonionic surfactants include, without limitation, sugar-based surfactants, particularly glucosamides, which are formed from glucose and fatty acids. In an embodiment, the compositions include one or more glucosamides which are EO-free, sulfate-free, and/or PEG-free. The polar head group of the glucoside and glucosamide classes of surfactants are shown below. Head groups are depicted in their ring open state.

### Glucoside Polar Head Group

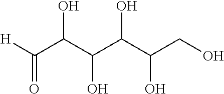 [SMILES: O=CC(O)C(O)C(O)C(O)CO]

### Glucosamide Polar Head Group

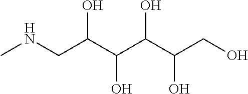

Examples of suitable glucosamides include, without limitation, capryloyl caproyl methyl glucamide, lauroyl myristoyl methyl glucamide, cocoyl methyl glucamide, sunfloweroyl methyl glucamide, coco-betaine, N-coconut acyl-N-methyl glucamine, N—C_{12/14} acyl-N-methyl glucamine, N—C_{8/10} acyl-N-methyl glucamine, or a combination thereof.

Preferred glucosamides are those having less than 18 carbons in the alkyl chain. More preferred are C₈-C₁₆ glucosamides which include. Most preferred are glucosamides having between about 8 and about 10 carbons in the alkyl chain. A particularly preferred glucosamide is capryloyl caproyl methyl glucamide, more particularly a D-Glucitol, 1-deoxy-1-(methylamino)-N—C8-10 acyl derivative, sold commercially as GLUCOTAIN® CLEAR (50%).

An additional group of suitable nonionic surfactants includes block polyoxypropylene-polyoxyethylene polymeric compounds (EO/PO block copolymers) based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available from BASF Corp. One class of compounds is difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds is tetra-functional block copolymers derived from the sequential addition of propylene oxide and ethylene oxide to ethylenediamine. The molecular weight of the propylene oxide ranges from about 500 to about 7,000; and the hydrophile, ethylene oxide, is added to constitute from about 10% by weight to about 80% by weight of the molecule.

Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range, or it can consist of an alcohol having a specific number of carbon atoms within this range. Examples of like commercial surfactant are available under the trade names Lutensol™, Dehydol™ manufactured by BASF, Neodol™ manufactured by Shell Chemical Co. and Alfonic™ manufactured by Vista Chemical Co.

Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range, or it can consist of an acid having a specific number of carbon atoms within the range. Examples of commercial compounds of this chemistry are available on the market under the trade names Disponil or Agnique manufactured by BASF and Lipopeg™ manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols are suitable. All of these ester moieties have one or more reactive hydrogen sites on their molecule which can undergo further acylation or ethylene oxide (alkoxide) addition to control the hydrophilicity of these substances. Care must be exercised when adding these fatty esters or acylated carbohydrates to compositions of the present disclosure containing amylase or lipase enzymes because of potential incompatibility.

Examples of nonionic low foaming surfactants include:

Nonionics which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse Pluronics™ are manufactured by BASF Corporation under the trade name Pluronic™ R surfactants. Likewise, the Tetronic™ R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

Nonionics which are modified by “capping” or “end blocking” the terminal hydroxy group or groups (of multi-functional moieties) to reduce foaming by reaction with a small hydrophobic molecule such as propylene oxide, butylene oxide, benzyl chloride; and short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

The alkylphenoxypolyethoxyalkanols of U.S. Pat. No. 2,903,486 issued Sep. 8, 1959, to Brown et al. and represented by the formula

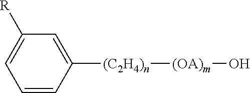

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962, to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968, to Lissant et al. having the general formula Z[(OR)ₙOH]_{z} wherein Z is alkoxylatable material, R is a group derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954, to Jackson et al. corresponding to the formula Y(C₃H₆O)ₙ(C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ(C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerin, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this disclosure correspond to the formula: P[(C₃H₆O)ₙ (C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

Polyhydroxy fatty acid amide surfactants suitable for use in the present compositions include those having the structural formula R₂CON_{R1}Z in which: R1 is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxy hydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

Fatty alcohol nonionic surfactants, including ethoxylated C₆-C₁₈ fatty alcohols and C₆-C₁₈ mixed ethoxylated and propoxylated fatty alcohols and fatty alcohol polyglycol ethers.

Suitable ethoxylated fatty alcohols include the C₆-C₁₈ ethoxylated fatty alcohols with a degree of ethoxylation of from 3 to 50.

Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, or 6-positions on the preceding saccharide units.

Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or —(C₂H₄O)ₓH, where x is in the range of from 1 to 3.

A useful class of nonionic surfactants include the class defined as alkoxylated amines or, most particularly, alcohol alkoxylated/aminated/alkoxylated surfactants. These nonionic surfactants may be at least in part represented by the general formulae: R²⁰—(PO)ₛN-(EO)ₜH, R²⁰—(PO)ₛN-(EO)ₜH(EO)ₜH, and R²⁰—N(EO)ₜH; in which R²¹ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰—(PO)ᵥ—N[(EO)_{w}H][(EO)_{z}H] in which R²¹ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A suitable chemical of this class includes Surfonic™ PEA 25 Amine Alkoxylate. Suitable nonionic surfactants for the compositions of the disclosure include alcohol alkoxylates, EO/PO block copolymers, alkylphenol alkoxylates, and the like.

The treatise Nonionic Surfactants, edited by Schick, M. J., Vol. 1 of the Surfactant Science Series, Marcel Dekker, Inc., New York, 1983 is an excellent reference on the wide variety of nonionic compounds generally employed in the practice of the present disclosure. A typical listing of nonionic classes, and species of these surfactants, is given in U.S. Pat. No. 3,929,678 issued to Laughlin and Heuring on Dec. 30, 1975. Further examples are given in “Surface Active Agents and detergents” (Vol. I and II by Schwartz, Perry and Berch).

When present, the compositions include one or more nonionic surfactants in an amount of between about 0 wt-% to about 30 wt-%, more preferably between about 1 wt-% and about 15 wt-%, and still more preferably between about 1 wt-% and about 5 wt-%.

In an RTU the one or more nonionic surfactants can be present in an amount of between about 0 wt-% to about 5 wt-%, more preferably between about 0.01 wt-% and about 3 wt-%, and still more preferably between about 0.01 wt-% and about 1 wt-%.

### Semi-Polar Nonionic Surfactants

In addition to the amine oxide semi-polar nonionic surfactants described herein, other semi-polar nonionic surfactants include phosphine oxides, sulfoxides and their alkoxylated derivatives.

Useful semi-polar nonionic surfactants also include the water-soluble phosphine oxides having the following structure:

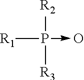

wherein the arrow is a conventional representation of a semi-polar bond; and R¹ is an alkyl, alkenyl or hydroxyalkyl moiety ranging from 10 to about 24 carbon atoms in chain length; and R² and R³ are each alkyl moieties separately selected from alkyl or hydroxyalkyl groups containing 1 to 3 carbon atoms.

Examples of useful phosphine oxides include dimethyldecylphosphine oxide, dimethyltetradecylphosphine oxide, methylethyltetradecylphosphone oxide, dimethyl hexadecyl phosphine oxide, diethyl-2-hydroxyoctyldecylphosphine oxide, bis(2-hydroxyethyl)dodecyl phosphine oxide, and bis(hydroxymethyl)tetradecyl phosphine oxide.

Semi-polar nonionic surfactants useful herein also include the water-soluble sulfoxide compounds which have the structure:

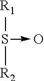

wherein the arrow is a conventional representation of a semi-polar bond; and R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms.

Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Semi-polar nonionic surfactants for the compositions of the disclosure include dimethyl amine oxides, such as lauryl dimethyl amine oxide, myristyl dimethyl amine oxide, combinations thereof, and the like. Useful water soluble amine oxide surfactants are selected from the octyl, decyl, dodecyl, isododecyl, coconut, or tallow alkyl di-(lower alkyl) amine oxides, specific examples of which are octyl dimethyl amine oxide, nonyl dimethyl amine oxide, decyl dimethyl amine oxide, undecyl dimethyl amine oxide, dodecyldimethyl amine oxide, iso-dodecyldimethyl amine oxide, lauryl dimethyl amine oxide (sold commercially as Barlox 12), tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Suitable nonionic surfactants suitable for use with the compositions of the present disclosure include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC11; mixtures thereof, or the like.

When present, the compositions include one or more nonionic surfactants in an amount of between about 0 wt-% to about 30 wt-%, more preferably between about 1 wt-% and about 15 wt-%, and still more preferably between about 1 wt-% and about 5 wt-%.

In an RTU the one or more nonionic surfactants can be present in an amount of between about 0 wt-% to about 5 wt-%, more preferably between about 0.01 wt-% and about 3 wt-%, and still more preferably between about 0.01 wt-% and about 1 wt-%.

### Cationic Surfactants

Surface active substances are classified as cationic if the charge on the hydrotrope portion of the molecule is positive. Surfactants in which the hydrotrope carries no charge unless the pH is lowered close to neutrality or lower, but which are then cationic (e.g., alkyl amines), are also included in this group. In theory, cationic surfactants may be synthesized from any combination of elements containing an “onium” structure RnX+Y— and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic or more water dispersible, more easily water solubilized by co-surfactant mixtures, or water soluble. For increased water solubility, additional primary, secondary or tertiary amino groups can be introduced, or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The simplest cationic amines, amine salts and quaternary ammonium compounds can be schematically drawn thus:

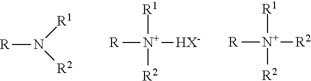

in which R represents an alkyl chain, R′, R″, and R′″ may be either alkyl chains or aryl groups or hydrogen and X represents an anion. The amine salts and quaternary ammonium compounds are suitable for practical use in this disclosure due to their high degree of water solubility.

The majority of large volume commercial cationic surfactants can be subdivided into four major classes and additional sub-groups known to those or skill in the art and described in “Surfactant Encyclopedia,” Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkyl benzyl dimethyl ammonium salts, alkyl benzene salts, heterocyclic ammonium salts, tetra alkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like.

Cationic surfactants useful in the compositions of the present disclosure include those having the formula R¹ₘR²ₓY_{L}Z wherein each R¹ is an organic group containing a straight or branched alkyl or alkenyl group optionally substituted with up to three phenyl or hydroxy groups and optionally interrupted by up to four of the following structures:

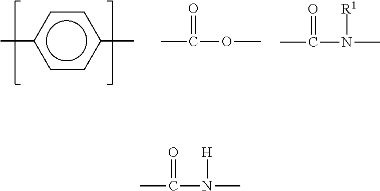

or an isomer or mixture of these structures, and which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6. The remainder of any carbon atom positions on the Y group are filled by hydrogens.

Y is a group including, but not limited to:

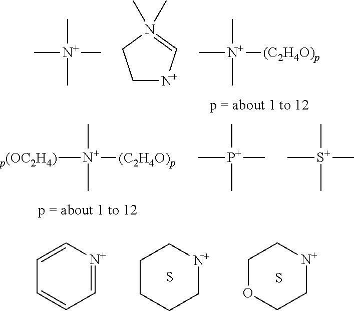

or a mixture thereof. Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water-soluble anion, such as a halide, sulfate, methylsulfate, hydroxide, or nitrate anion, particularly suitable being chloride, bromide, iodide, sulfate or methyl sulfate anions, in a number to give electrical neutrality of the cationic component.

Additional suitable cationic surfactants include those derived from coconut products such as coconut oil or coconut fatty acid. Additional suitable coconut derived surfactants include, for example, complex fatty tertiary amines with cationic surfactant properties, both as free amines and in the salt form. Such surfactants include, but are not limited to N,N-Diethoxylated-N-coco-N-methylammonium chloride (also sometimes referred to as Coconut oil alkyl)bis(2-hydroxyethyl, ethoxylated)methylammonium

Chloride) Such surfactants are commercially available under the trade names Ameenex™, specifically Ameenix™ 1154 and Rewoquat, specifically Rewoquat CQ 100 G.

When present, the compositions include one or more cationic surfactants in an amount of between about 0 wt-% to about 30 wt-%, more preferably between about 1 wt-% and about 15 wt-%, and still more preferably between about 1 wt-% and about 5 wt-%.

In an RTU the one or more cationic surfactants can be present in an amount of between about 0 wt-% to about 5 wt-%, more preferably between about 0.01 wt-% and about 3 wt-%, and still more preferably between about 0.01 wt-% and about 1 wt-%.

However, in an embodiment, the compositions are free of cationic surfactants.

### Zwitterionic Surfactants

Zwitterionic surfactants can be thought of as a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong” inner-salt” attraction between positive-negative charge centers. Examples of such zwitterionic synthetic surfactants include derivatives of aliphatic quaternary ammonium, phosphonium, and sulfonium compounds, in which the aliphatic groups can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

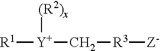

wherein R¹ contains an alkyl, alkenyl, or hydroxyalkyl group of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a group selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[5-3-hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio)-2-hydroxy-propane-1-sulfonate; 4-[N,N-di(2(2-hydroxyethyl)-N(2-hydroxydodecyl)ammonio]-butane-1-carboxylate; 3-[S-ethyl-S-(3-dodecoxy-2-hydroxypropyl)sulfonio]-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

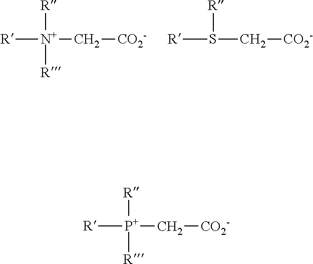

These surfactant betaines typically do not exhibit strong cationic or anionic characters at pH extremes, nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Sultaines useful in the present disclosure include those compounds having the formula (R(R′)₂ N⁺ R²SO³⁻, in which R is a C₆-C₁₈ hydrocarbyl group, each R¹ is typically independently C₁-C₃ alkyl, e.g., methyl, and R² is a C₁-C₆ hydrocarbyl group, e.g., a C₁-C₃ alkylene or hydroxyalkylene group.

When present, the compositions include one or more zwitterionic surfactants in an amount of between about 0 wt-% to about 30 wt-%, more preferably between about 1 wt-% and about 15 wt-%, and still more preferably between about 1 wt-% and about 5 wt-%.

In an RTU the one or more zwitterionic surfactants can be present in an amount of between about 0 wt-% to about 5 wt-%, more preferably between about 0.01 wt-% and about 3 wt-%, and still more preferably between about 0.01 wt-% and about 1 wt-%.

### Solvent

In an embodiment, the compositions optionally include one or more solvents. In an embodiment, the solvent comprises water, an alcohol, an ester, a glycol ether, an amide, a hydrocarbon, or a combination thereof. More particularly, suitable solvents include an aromatic alcohol, alkanol amine, ether amine, glycol ether, an ester, or a combination thereof.

In preferred embodiments the solvents do not include N-alkylpyrrolidones or derivatives thereof which can be referred to as either solvent of surfactants (as a class of cyclic amides).

Examples of other suitable solvents include, without limitation, lower alkanols, lower alkyl ethers, and lower alkyl glycol ethers. Examples of such useful solvents include methanol, ethanol, propanol, isopropanol and butanol, isobutanol, ethylene glycol, diethylene glycol, triethylene glycol, propylene glycol, hexylene glycol, dipropylene glycol, mixed ethylene-propylene glycol ethers, or a combination thereof. The glycol ethers include lower alkyl (C1-8 alkyl) ethers such as propylene glycol methyl ether, propylene glycol ethyl ether, propylene glycol propyl ether, dipropylene glycol methyl ether, dipropylene glycol ethyl ether, tripropylene glycol methyl ether, ethylene glycol methyl ether, ethylene glycol ethyl ether, ethylene glycol butyl ether, diethylene glycol methyl ether, diethylene glycol butyl ether, ethylene glycol dimethyl ether, ethylene glycol monobutyl ether, or a combination thereof.

Other examples of suitable solvents include acetamidophenol, acetanilide, acetophenone, 2-acetyl-1-methylpyrrole, benzyl acetate, benzyl alcohol, methyl benzyl alcohol, alpha phenyl ethanol, benzyl benzoate, benzyloxyethanol, ethylene glycol phenyl ether, propylene glycol phenyl ether, amyl acetate, amyl alcohol, butanol, 3-butoxyethyl-2-propanol, butyl acetate, n-butyl propionate, cyclohexanone, diacetone alcohol, diethoxyethanol, diethylene glycol methyl ether, diisobutyl carbinol, diisobutyl ketone, dimethyl heptanol, dipropylene glycol tert-butyl ether, ethanol, ethyl acetate, 2-ethylhexanol, ethyl propionate, ethylene glycol methyl ether acetate, hexanol, isobutanol, isobutyl acetate, isobutyl heptyl ketone, isophorone, isopropanol, isopropyl acetate, methanol, methyl amyl alcohol, methyl n-amyl ketone, 2-methyl-1-butanol, methyl ethyl ketone, methyl isobutyl ketone, 1-pentanol, n-pentyl propionate, 1-propanol, n-propyl acetate, n-propyl propionate, propylene glycol ethyl ether, tripropylene glycol methyl ether, tripropylene glycol n-butyl ether, diethylene glycol n-butyl ether acetate, diethylene glycol monobutyl ether, ethylene glycol n-butyl ether acetate, ethylene glycol monobutyl ether, dipropylene glycol monobutyl ether, propylene glycol monobutyl ether, ethyl 3-ethoxypropionate, 2,2,4-trimethyl-1,3-pentanediol monoisobutyrate, diethylene glycol monohexyl ether, ethylene glycol monohexyl ether, diethylene glycol monomethyl ether, diethylene glycol monoethyl ether, ethylene glycol methyl ether acetate, ethylene glycol monomethyl ether, dipropylene glycol monomethyl ether, propylene glycol methyl ether acetate, propylene glycol monomethyl ether, diethylene glycol monopropyl ether, ethylene glycol monopropyl ether, dipropylene glycol monopropyl ether, propylene glycol monopropyl ether, or a combination thereof.

When present in the compositions, the solvent(s) may be present in an amount of between about 0 wt-% to about 15 wt-%, preferably between about 0.1 wt-% and 10 wt-%, still more preferably between about 0.1 wt-% and 5 wt-%.

In an RTU the solvent(s) can be present in an amount of between about 0 wt-% to about 5 wt-%, more preferably between about 0.01 wt-% and about 3 wt-%, and still more preferably between about 0.01 wt-% and about 1 wt-%.

### Alkalinity Source

In an embodiment, the compositions include one or more sources of alkalinity to aid in soil removal efficacy. The alkalinity source can include an alkali metal carbonate, an alkali metal hydroxide, alkali metal silicate, alkali metal metasilicate, or a combination thereof.

Alkali metal carbonates are often referred to as ash-based detergents and most often employ sodium carbonate. Additional alkali metal carbonates include, for example, sodium or potassium carbonate, bicarbonate, sesquicarbonate, or a combination thereof. In an aspect, the alkali metal carbonates are further understood to include metasilicates, silicates, bicarbonates and sesquicarbonates. As described herein, any “ash-based” or “alkali metal carbonate” shall also be understood to include all alkali metal carbonates, metasilicates, silicates, bicarbonates and/or sesquicarbonates, and salts thereof, such as sodium, potassium, and lithium salts.

Alkali metal hydroxides are often referred to as caustic detergents. Examples of suitable alkali metal hydroxides include sodium hydroxide, potassium hydroxide, and lithium hydroxide. Exemplary alkali metal salts include sodium carbonate, potassium carbonate, and mixtures thereof. The alkali metal hydroxides may be added to the composition in any suitable form, including solid beads, an aqueous solution, or a combination thereof. Alkali metal hydroxides are commercially available as a solid in the form of prilled solids or beads having a mix of particle sizes ranging from about 12-100 U.S. mesh, or as an aqueous solution, such as for example, as a 45% and a 50% by weight solution.

In addition to a first alkalinity source, the composition may comprise a second source of alkalinity. In a preferred embodiment, the composition includes sodium carbonate. In a further embodiment, the composition includes sodium carbonate and sodium metasilicate.

An effective amount of one or more alkalinity sources is provided in the detergent composition. An effective amount is referred to herein as an amount that provides a use composition having a pH of between about 8 to about 13, more preferably, between about 9 to about 12.

When present in the compositions, the alkalinity source may be present in an amount of between about 0 wt-% to about 15 wt-%, preferably between about 0.1 wt-% and 10 wt-%, still more preferably between about 0.1 wt-% and 5 wt-%.

In an RTU the alkalinity source can be present in an amount of between about 0 wt-% to about 5 wt-%, more preferably between about 0.01 wt-% and about 3 wt-%, and still more preferably between about 0.01 wt-% and about 1 wt-%.

### Fillers and Carriers

In some embodiments, the compositions can include one or more fillers and/or carriers. Fillers are sometimes generally inert but may cooperate with surfactants to enhance the overall capacity of the composition. In other circumstances, some fillers provide secondary benefits. For example, fillers as used in cleaning compositions may help the composition to flow freely and improve dispersion. Some examples of suitable fillers may include, without limitation, sodium sulfate, sodium chloride, a starch, a sugar, a C₁-C₁₀ alkylene glycol such as propylene glycol, or a combination thereof.

When present in the compositions, the fillers and carriers may be present in an amount of between about 0 wt-% to about 15 wt-%, preferably between about 0.1 wt-% and 10 wt-%, still more preferably between about 0.1 wt-% and 5 wt-%.

In an RTU the fillers and carriers can be present in an amount of between about 0 wt-% to about 5 wt-%, more preferably between about 0.01 wt-% and about 3 wt-%, and still more preferably between about 0.01 wt-% and about 1 wt-%.

### Additional Functional Ingredients

The compositions optionally can further be combined with one or more additional functional ingredients. The functional ingredients provide desired properties and functionalities to the compositions. For the purpose of this application, the term “functional ingredient” includes a material that when dispersed or dissolved in a use or concentrate solution, such as an aqueous solution, provides a beneficial property in a particular use. Some particular examples of functional materials are discussed in more detail below, although the particular materials discussed are given by way of example only, and that a broad variety of other functional ingredients may be used.

Additional functional ingredients may include further defoaming agents, drying-enhancers, propellants, bleaching agents or optical brighteners, solubility modifiers, buffering agents, dye transfer inhibiting agents, dispersants, stabilizing agents, sequestrants or chelating agents to coordinate metal ions and control water hardness, microbial synergists or dyes, rheology modifiers or thickeners, hydrotropes or couplers, buffers, solvents, pH buffers, colorants, and the like.

### Drying Agent

The compositions can optionally comprise a drying agent comprising an alcohol solvent. The inclusion of a drying agent aids in drying properties of the composition, e.g. when the composition is used as a spray or a wipe. Drying agents include components that evaporate rapidly, such as alcohol solvents. Exemplary alcohol drying agents include for example, methanol, ethanol, propanol, isopropanol, butanol, isobutanol, 2-butoxyethanol, 1-decanol, benzyl alcohol and the like.

Preferred drying agents comprise ethanol, isopropanol or combinations thereof. In some embodiments the drying agents further enhance antimicrobial activity of the composition and can aid as an antimicrobial active.

When present, the compositions include one or more drying agents in an amount of between about 0 wt-% to about 15 wt-%, more preferably between about 1 wt-% and about 15 wt-%, and still more preferably between about 5 wt-% and about 10 wt-%. The weight percentage ranges of drying agent(s) at RTU or use solution provides a non-flammable composition.

### Colorant

The compositions can optionally comprise a colorant. Preferred colorants include natural and synthetic colorants or dyes. Most preferably the colorant comprises FD&C Blue 1 (Sigma Chemical), FD&C Yellow 5 (Sigma Chemical), Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), or a combination thereof.

In an aspect, the colorant or dye may comprise dyes which are generally recognized as safe. Suitable dyes include, but are not limited to, FDC Blue #1, FDC Blue #2, FDC Green #3, FDC Red #3, FDC Red #4, FDC Red #40, Violet #1, FDC Yellow #5, and FDC Yellow #6.

When present, the compositions include a colorant in an amount of between about 0 wt-% to about 5 wt-%, more preferably between about 0.001 wt-% and about 5 wt-%, and still more preferably between about 0.005 wt-% and about 2 wt-%.

### Preservative

The compositions may also optionally include one or more preservatives in addition to the carboxylic acid salt preservative. Suitable preservatives include a carboxylic acid salt, phenolic, halogen compound, metal derivative, amine, alkanolamine, nitro derivative, biguanide, analide, organosulfur and sulfur-nitrogen compound, alkyl paraben, and other compounds.

Suitable phenolic compounds include, but are not limited to, pentachlorophenol, orthophenylphenol, chloroxylenol, p-chloro-m-cresol, p-chlorophenol, chlorothymol, m-cresol, o-cresol, p-cresol, isopropyl cresols, mixed cresols, phenoxyethanol, phenoxyethylparaben, phenoxyisopropanol, phenyl paraben, resorcinol, and derivatives thereof. Suitable halogen compounds include but are not limited to iodine-poly(vinylpyrrolidin-onen) complexes, and bromine compounds such as 2-bromo-2-nitropropane-1,3-diol, and derivatives thereof. Suitable amines and nitro containing compounds include, but are not limited to, hexahydro-1,3,5-tris(2-hydroxyethyl)-s-triazine, dithiocarbamates such as sodium dimethyldithiocarbamate, and derivatives thereof. Suitable biguanides include, but are not limited to, polyaminopropyl biguanide and chlorhexidine gluconate. Suitable alkyl parabens include, but are not limited to, methyl, ethyl, propyl and butyl parabens. Other preservatives include, but are not limited to, phospholipid preservatives, such as triglyceride phospholipids. A suitable example is cocamidopropyl phosphatidyl PG-dimonium chloride (e.g., COLA®LIPID C).

When present, the compositions include a preservative in an amount of between about 0 wt-% to about 5 wt-%, more preferably between about 0.001 wt-% and about 5 wt-%, and still more preferably between about 0.005 wt-% and about 2 wt-%.

### Additional Antimicrobial Agents

In some embodiments, the compositions can optionally include an additional antimicrobial or sanitizing agent. Sanitizing agents also known as antimicrobial agents are chemical compositions that can be used to prevent microbial growth and/or contamination and deterioration of material systems, surfaces, etc. Generally, these materials fall in specific classes including phenolics, halogen compounds, quaternary ammonium compounds, metal derivatives, amines, alkanol amines, nitro derivatives, analides, organosulfur and sulfur-nitrogen compounds and miscellaneous compounds. However, in an embodiment the compositions are free of additional antimicrobial agents.

Some examples of common antimicrobial agents include phenolic antimicrobials such as pentachlorophenol, orthophenylphenol, a chloro-p-benzylphenol, p-chloro-m-xylenol. Halogen containing antibacterial agents include sodium trichloroisocyanurate, sodium dichloro isocyanate (anhydrous or dihydrate), iodine-poly(vinylpyrolidinone) complexes, bromine compounds such as 2-bromo-2-nitropropane-1,3-diol, and quaternary ammonium compounds, such as benzalkonium chloride, didecyldimethyl ammonium chloride, dialkyl dimethyl ammonium chloride, alkyl dimethyl benzyl ammonium chloride, choline diiodochloride, tetramethyl phosphonium tribromide, or a combination thereof. Other antimicrobial compositions such as hexahydro-1,3,5-tris(2-hydroxyethyl)-s- -triazine, dithiocarbamates such as sodium dimethyldithiocarbamate.

When present, the compositions include an additional antimicrobial agent in an amount of between about 0 wt-% to about 5 wt-%, more preferably between about 0.1 wt-% and about 5 wt-%, and still more preferably between about 0.5 wt-% and about 5 wt-%.

### Methods for Treating a Target

Also disclosed herein are methods for treating a surface or a target, wherein the method comprises contacting a surface or a target with an effective amount of the acidic antimicrobial composition described herein to form a treated surface or target composition, and the contacting step lasts for sufficient time to stabilize or reduce microbial population in and/or on the surface or target or the treated surface of target composition.

In some embodiments, the target to be treated by the present methods can be a food item or a plant item and/or at least a portion of a medium, a container, an equipment, a system or a facility for growing, holding, processing, packaging, storing, transporting, preparing, cooking or serving the food item or the plant item. Any suitable concentration of the acidic antimicrobial composition can be used in the present methods. For example, the composition can be used at a concentration of from about 1 ppm to about 100,000 ppm, e.g., about 1-2 ppm, 2-3 ppm, 3-4 ppm, 4-5 ppm, 5-6 ppm, 6-7 ppm, 7-8 ppm, 8-9 ppm, 9-10 ppm, 10-15 ppm, 15-20 ppm, 20-25 ppm, or 25-30 ppm, 30-40 ppm, 40-50 ppm, 50-60 ppm, 60-70 ppm, 70-80 ppm, 80-90 ppm, 90-100 ppm, 100-200 ppm, 200-300 ppm, 300-400 ppm, 400-500 ppm, 500-600 ppm, 600-700 ppm, 700-800 ppm, 800-900 ppm, 900-1,000 ppm, 1,000-2,000 ppm, 2,000-3,000 ppm, 3,000-4,000 ppm, 4,000-5,000 ppm, 5,000-6,000 ppm, 6,000-7,000 ppm, 7,000-8,000 ppm, 8,000-9,000 ppm, 9,000-10,000 ppm, 10,000-20,000 ppm, 20,000-30,000 ppm, 30,000-40,000 ppm, 40,000-50,000 ppm, 50,000-60,000 ppm, 60,000-70,000 ppm, 70,000-80,000 ppm, 80,000-90,000 ppm, or 90,000-100,000 ppm.

In some embodiments, the target is a food item or a plant item and the contacting step minimizes or does not induce an organoleptic effect in or adulterate the food item or a plant item.

The present methods can be used for treating any suitable agricultural product (also referred to as a farm product), such as a plant item, a food item, or the like. In some embodiments, the plant item is a grain, fruit, vegetable or flower plant item. In other embodiments, the plant item is a living plant item or a harvested plant item. In still other embodiments, the plant item comprises a seed, a tuber, a growing plant, a cutting, or a root stock. In yet other embodiments, the present methods are used for treating a living plant tissue comprising treating the plant tissue with the above composition in a diluted concentration to stabilize or reduce microbial population in and/or on the plant tissue.

Relatedly, the methods may be used for treating a surface on a farm premises. In an embodiment, the surfaces on the farm premises is a device, apparatus, machine, pipe, hose, conduit, tube, nozzle, sprayer, carousel, shaft, cavity, container, vat, or rail used in a farm process or production of a farm product.

The present methods can be used for treating any suitable food item. For example, the food item can be an animal product, e.g., an animal carcass or an egg, a fruit item, a vegetable item, or a grain item. In some embodiments, the animal carcass can be a beef, pork, veal, buffalo, lamb, fish, sea food or poultry carcass. In other embodiments, the seafood carcass can be a scallop, shrimp, crab, octopus, mussel, squid or lobster. In still other embodiments, the fruit item can be a botanic fruit, a culinary fruit, a simple fruit, an aggregate fruit, a multiple fruit, a berry, an accessory fruit or a seedless fruit. In yet other embodiments, the vegetable item can be a flower bud, a seed, a leaf, a leaf sheath, a bud, a stem, a stem of leaves, a stem shoot, a tuber, a whole-plant sprout, a root or a bulb. In yet other embodiments, the grain item can be maize, rice, wheat, barley, sorghum, millet, oat, triticale, rye, buckwheat, fonio or quinoa.

In some embodiments, the target to be treated by the present methods can be a medium, a surface, a container, an equipment, or a system in a health care facility, e.g., a physical office or a hospital. Any suitable concentration of the composition can be used in the present methods. For example, the composition can be used at a concentration of from about 1 ppm to about 100,000 ppm, e.g., about 1-2 ppm, 2-3 ppm, 3-4 ppm, 4-5 ppm, 5-6 ppm, 6-7 ppm, 7-8 ppm, 8-9 ppm, 9-10 ppm, 10-15 ppm, 15-20 ppm, 20-25 ppm, or 25-30 ppm, 30-40 ppm, 40-50 ppm, 50-60 ppm, 60-70 ppm, 70-80 ppm, 80-90 ppm, 90-100 ppm, 100-200 ppm, 200-300 ppm, 300-400 ppm, 400-500 ppm, 500-600 ppm, 600-700 ppm, 700-800 ppm, 800-900 ppm, 900-1,000 ppm, 1,000-2,000 ppm, 2,000-3,000 ppm, 3,000-4,000 ppm, 4,000-5,000 ppm, 5,000-6,000 ppm, 6,000-7,000 ppm, 7,000-8,000 ppm, 8,000-9,000 ppm, 9,000-10,000 ppm, 10,000-20,000 ppm, 20,000-30,000 ppm, 30,000-40,000 ppm, 40,000-50,000 ppm, 50,000-60,000 ppm, 60,000-70,000 ppm, 70,000-80,000 ppm, 80,000-90,000 ppm, or 90,000-100,000 ppm.

The present methods can be used for treating a target that is at least a portion of a container, an equipment, a system or a facility for holding, processing, packaging, storing, transporting, preparing, cooking or serving the food item or the plant item. In some embodiments, the target is at least a portion of a container, an equipment, a system or a facility for holding, processing, packaging, storing, transporting, preparing, cooking or serving a meat item, a fruit item, a vegetable item, or a grain item. In other embodiments, the target is at least a portion of a container, an equipment, a system or a facility for holding, processing, packaging, storing, or transporting an animal carcass. In still other embodiments, the target is at least a portion of a container, an equipment, a system or a facility used in food processing, food service or health care industry. In yet other embodiments, the target is at least a portion of a fixed in-place process facility. An exemplary fixed in-place process facility can comprise a milk line dairy, a continuous brewing system, a pumpable food system or a beverage processing line.

The present methods can be used for treating a target that is at least a portion of a solid surface or liquid media. In some embodiments, the solid surface is an inanimate solid surface. The inanimate solid surface can be contaminated by a biological fluid, e.g., a biological fluid comprising blood, other hazardous body fluid, or a mixture thereof. In other embodiments, the solid surface can be a contaminated surface. An exemplary contaminated surface can comprise the surface of food service wares or equipment, or the surface of a fabric.

The compositions can be applied in any suitable manner. In some embodiments, the compositions can be applied to a target by means of a spray, a soak, a fog, a foam, a wipe, or by dipping all or part of the target in a composition comprising the composition. In some embodiments, the composition is applied to the target by means of a spray, a soak, a fog, or a wipe. In other embodiments, the diluted composition is applied to the target by applying in the form of a thickened or gelled solution. In still other embodiments, all or part of the target is dipped in the composition. The target and/or the composition can be subject to any suitable movement to help or facilitate the contact between the target and the composition. In some embodiments, the composition can be agitated. In other embodiments, the composition can be sprayed onto a target, e.g., an animal carcass, under suitable pressure and at a suitable temperature.

The contacting step in the present methods can last for any suitable amount of time. In some embodiments, the contacting step can last for at least about 10 seconds. For example, the contacting step can last for at least about 10, 20, 30, 40, 50 seconds, 1 minute, 1-2 minutes, 2-3 minutes, 3-4 minutes, 4-5 minutes, 5-6 minutes, 6-7 minutes, 7-8 minutes, 8-9 minutes, or 9-10 minutes, 10-15 minutes, 15-20 minutes, 20-25 minutes, 25-30 minutes, 30-40 minutes, 40-50 minutes, 50-65 minutes, 1-2 hours, 2-3 hours, 3-4 hours, 4-5 hours, 5-6 hours, 6-7 hours, 7-8 hours, 8-9 hours, or 9-10 hours, 16 hours, 1 day, 3 days, 1 week, or longer.

The present methods can be used to reduce microbial population in and/or on the target or the treated target composition by any suitable magnitude. In some embodiments, the present methods can be used to reduce microbial population in and/or on the target or the treated target composition by at least one log₁₀, two log₁₀, three log₁₀, four log₁₀, five log₁₀, or more. In other embodiments, the level of a microorganism, if present in and/or on the target or the treated target composition, can be stabilized or reduced by the present methods. For example, at least 10%, 20%, 30%, 40%, 50%, 60%, 70%, 80%, or 90% or more of the microorganism, if present in and/or on the target or the treated target composition, can be killed, destroyed, removed and/or inactivated by the present methods.

The present methods can be used to reduce the population of any suitable microbe(s) in and/or on the target or the treated target composition by any suitable magnitude. In some embodiments, the present methods can be used to reduce a prokaryotic microbial population, e.g., a bacterial or an archaeal population. In other embodiments, the present methods can be used to reduce a eukaryotic microbial population, e.g., a protozoal or fungal population, e.g. Saccharomyces cerevisiae, Penicillium digitatum. In still other embodiments, the present methods can be used to reduce a viral population. Exemplary viral population can comprise a population of a DNA virus, an RNA virus, and a reverse transcribing virus.

The microbial populations that are reduced by the methods can include prokaryotic microbial populations, eukaryotic microbial population, or viral populations. The microbial populations that are reduced by the methods can include gram positive and gram-negative bacteria. Exemplary gram-positive bacteria include for example, Staphylococcus aureus, Bacillus species (sp.) like Bacillus subtilis, Clostridia sp., Pediococcus damnosus, Lactobacillus malefermentas or Clostridium butyricum. Exemplary gram-negative bacteria include for example, Escherichia coli, Pseudomonas sp., Klebsiella pneumoniae, Klebsiella aerogenes, Legionella pneumophila, Enterobacter sp., Serratia sp., Desulfovibrio sp., and Desulfotomaculum sp.

In embodiments, the methods reduce non-food contact surface microbial populations to provide at least a 3-log reduction within 5 minutes or less in an in vitro assay against Klebsiella aerogenes and/or Staphylococcus aureus. A standard measurement for the in vitro assay is ASTM E1153: Standard Test Method for Efficacy of Sanitizers Recommended for Inanimate, Hard, Nonporous Non-Food Contact Sanitizer Surfaces.

In embodiments, the methods reduce food contact surface microbial populations to provide at least a 5-log reduction within 30 seconds or less in an in vitro assay against Staphylococcus aureus and/or Escherichia coli. A standard measurement for the in vitro assay is AOAC Method 960.09: Germicidal & Detergent Sanitizing Action of Disinfectants.

In embodiments, the methods reduce non-pathogenic organisms or non-public health organisms or microbial populations to provide at least a 1-log reduction within 1 minute in an in vitro assay against Pediococcus damnosus, Lactobacillus malefermentas, Bacillus coagulants, Saccharomyces cerevisiae, Penicillium digitatum and/or Clostridium butyricum. A standard measurement for the in vitro assay is AOAC Method 960.09: Germicidal & Detergent Sanitizing Action of Disinfectants.

In embodiments, the methods reduce viral populations or viruses on a surface or substrate to provide at least a 3-log order reduction, or preferably a 5-log order reduction, or more preferably a complete inactivation of viruses within 5 minutes in an in vitro assay according to one of the following standards: ASTM E1053 Standard Test Method for Efficacy of Virucidal Agents Intended for Inanimate Environmental Surfaces; EPA 810.2200; or EN 14476.

The log reduction of a non-pathogenic organism can be used for reducing soilage-causing and slime forming microorganisms on various surfaces, including hard surfaces (both food and non-food contact surfaces). In some embodiments the methods are useful in reducing non-pathogenic organisms and do not require or use a rinse step thereafter treating the surface, and are often referred to as an antimicrobial rinse for the surface, instead of a sanitizing or disinfecting of the surface. The present methods can be conducted at any suitable temperature range. In some embodiments, the present methods can be conducted at a temperature ranging from about 0° C. to about 70° C., e.g., about 0° C.-1° C., 1° C.-2° C., 2° C.-3° C., 3° C.-4° C., 4° C.-5° C., 5° C.-10° C., 10° C.-15° C., 15° C.-20° C., 20° C.-25° C., 25° C.-30° C., 30° C.-35° C., 35° C.-40° C., 40° C.-45° C., 45° C.-50° C., 50° C.-55° C., 55° C.-60° C., 60° C.-65° C., or 65° C.-70° C. In other embodiments, the present methods can be conducted at a temperature at or lower than 0° C.

### Methods of Treating a Water Source

The present methods can be used to treat any suitable surface or target. In some embodiments, the target is water, and the present methods can comprise providing an effective amount of the composition to a water source in need of treatment to form a treated water source. For example, the composition can be used at a concentration of from about 1 ppm to about 100,000 ppm of the composition, e.g., about 1-2 ppm, 2-3 ppm, 3-4 ppm, 4-5 ppm, 5-6 ppm, 6-7 ppm, 7-8 ppm, 8-9 ppm, 9-10 ppm, 10-15 ppm, 15-20 ppm, 20-25 ppm, or 25-30 ppm, 30-40 ppm, 40-50 ppm, 50-60 ppm, 60-70 ppm, 70-80 ppm, 80-90 ppm, 90-100 ppm, 100-200 ppm, 200-300 ppm, 300-400 ppm, 400-500 ppm, 500-600 ppm, 600-700 ppm, 700-800 ppm, 800-900 ppm, 900-1,000 ppm, 1,000-2,000 ppm, 2,000-3,000 ppm, 3,000-4,000 ppm, 4,000-5,000 ppm, 5,000-6,000 ppm, 6,000-7,000 ppm, 7,000-8,000 ppm, 8,000-9,000 ppm, 9,000-10,000 ppm, 10,000-20,000 ppm, 20,000-30,000 ppm, 30,000-40,000 ppm, 40,000-50,000 ppm, 50,000-60,000 ppm, 60,000-70,000 ppm, 70,000-80,000 ppm, 80,000-90,000 ppm, 90,000-100,000 ppm. The present methods can be used to treat any suitable water source. For example, a water source in need of treatment can be fresh water, pond water, sea water, produced water, paper manufacturing water, tower water, wastewater, or a combination thereof.

The compositions can be used for a variety of industrial applications, e.g., to reduce microbial or viral populations on a surface or object or in a body or stream of water. In some aspects, the disclosure includes methods of using the compositions to prevent biological fouling in various industrial processes and industries, including oil and gas operations, to control microorganism growth, eliminate microbial contamination, limit or prevent biological fouling in liquid systems, including on membrane surfaces, or on the surfaces of equipment that come in contact with such liquid systems. As referred to herein, microbial contamination can occur in various industrial liquid systems including, but not limited to, airborne contamination, water make-up, process leaks and improperly cleaned equipment.

In one aspect, the water source in need of treatment may vary significantly. For example, the water source may be a freshwater source (e.g. pond water), salt water or brine source, brackish water source, recycled water source, wastewater, or the like.

When the target is a water source, the compositions may be in contact with the water in need of treatment for occurrence of time sufficient for antimicrobial effect. The contact time can vary with concentration of the use compositions, method of applying the use compositions, temperature of the use compositions, pH of the use compositions, amount of water to be treated, amount of soil or substrates in the water to be treated, or the like. The contact or exposure time can be at least about 15 seconds. In some embodiments, the exposure time is about 1 to 5 minutes. In other embodiments, the exposure time is at least about 10 minutes, 30 minutes, or 60 minutes. In other embodiments, the exposure time is a few minutes to hours. The contact time will further vary based upon the concentration of the composition in a use solution.

### Methods of Treating Food, Agricultural, and Health Care Surfaces

As noted above, the present methods are useful in the cleaning or sanitizing of processing facilities or equipment in the food service, food processing, agricultural/farm, and/or health care industries. Examples of process facilities in which the present methods can be employed include a milk line dairy, a continuous brewing system, food processing lines such as pumpable food systems and beverage lines, etc. Food service wares can also be disinfected with the present methods. The present methods are also useful in sanitizing or disinfecting solid surfaces such as floors, counters, furniture, medical tools and equipment, etc., found in the health care industry. Such surfaces often become contaminated with liquid body spills such as blood, other hazardous body fluids or mixtures thereof.

Generally, the actual cleaning of the in-place system or other surface (i.e., removal of unwanted offal therein) can be accomplished with a different material such as a formulated detergent which is introduced with heated water. After this cleaning step, the composition can be applied or introduced into the system at a use solution concentration in unheated, ambient temperature water. In some embodiments, the composition remains in solution in cold (e.g., 40° F./4° C.) water and heated (e.g., 140° F./60° C.) water.

In some embodiments, a method of sanitizing substantially fixed in-place process facilities comprises the following steps. The composition of the present disclosure is introduced into the process facilities at a temperature in the range of about 4° C. to about 60° C. After introduction of the use solution, the solution is circulated throughout the system for a time sufficient to sanitize the process facilities (i.e., to kill undesirable microorganisms). After the system has been sanitized by means of the present composition, the use composition or solution is drained from the system. Upon completion of the sanitizing step, the system optionally may be rinsed with other materials such as potable water.

The present composition is preferably circulated through the process facilities for 10 minutes or less.

In other embodiments, the present composition may also be employed by dipping food processing equipment into the diluted (or use) composition or solution of the present disclosure, soaking the equipment for a time sufficient to sanitize the equipment, and wiping or draining excess solution off the equipment. The composition may be further employed by spraying or wiping food processing surfaces with the use solution, keeping the surfaces wet for a time sufficient to sanitize the surfaces, and removing the excess composition or solution by wiping, draining vertically, vacuuming, etc.

In still other embodiments, the present composition may also be used in a method of cleaning and sanitizing hard surfaces such as institutional type equipment, utensils, dishes, health care equipment or tools, and other hard surfaces. The presently disclosed compositions may also be employed in cleaning and sanitizing clothing items or fabric which has become contaminated. The composition is contacted with any of the above contaminated surfaces or items at use temperatures in the range of about 4° C. to about 60° C. for a period of time effective to sanitize, disinfect, or sterilize the surface or item.

The present composition can be applied to growing plant tissues and can provide residual antimicrobial effects after the plant has completed its growth cycle, fruit or vegetable material have been harvested and sent to market. The present composition can be an effective treatment of living or growing plant tissues including seeds, roots, tubers, seedlings, cuttings, rooting stock, growing plants, produce, fruits and vegetables, etc.

In some embodiments, the compositions of the present disclosure can be used in a method of treating animal carcasses to obtain a reduction by at least one log₁₀ in surface microbial population which method includes the step of treating the carcass with a composition of the present disclosure, to reduce the microbial population.

The antimicrobial composition can be applied in various ways to obtain intimate contact with each potential place of microbial contamination. For example, it can be sprayed on the carcasses, or the carcasses can be immersed in the composition. Additional methods include applying a foamed composition and a thickened or gelled composition. Vacuum and or light treatments can be included, if desired, with the application of the antimicrobial composition. Thermal treatment can also be applied, either pre-, concurrent with or post application of the antimicrobial composition.

The compositions of the present disclosure may be applied in a variety of areas including kitchens, bathrooms, factories, hospitals, dental offices and food plants, and may be applied to a variety of hard or soft surfaces having smooth, irregular or porous topography. Suitable hard surfaces include, for example, architectural surfaces (e.g., floors, walls, windows, sinks, tables, counters and signs); eating utensils; hard-surface medical or surgical instruments and devices; and hard-surface packaging. Such hard surfaces may be made from a variety of materials including, for example, ceramic, metal, glass, wood or hard plastic. Suitable soft surfaces include, for example paper; filter media, hospital and surgical linens and garments; soft-surface medical or surgical instruments and devices; and soft-surface packaging. Such soft surfaces may be made from a variety of materials including, for example, paper, fiber, woven or non-woven fabric, soft plastics and elastomers. The diluted (or use) compositions may also be applied to soft surfaces such as food and skin (e.g., a hand). The diluted (or use) compositions may be employed as a foaming or non-foaming environmental sanitizer or disinfectant. In some embodiments it is desirable that a foaming profile similar to that of quaternary ammonium compounds can be achieved with the antimicrobial compositions, resulting in the antimicrobial compositions being readily available to swap out for previously used quaternary ammonium compound containing compositions.

In other embodiments, the compositions of the present disclosure may be included in products such as sterilants, sanitizers, disinfectants, preservatives, deodorizers, antiseptics, fungicides, germicides, sporicides, virucides, detergents, bleaches, hard surface cleaners, hand soaps, waterless hand sanitizers, and pre- or post-surgical scrubs.

In still other embodiments, the compositions of the present disclosure may also be used in veterinary products such as mammalian skin treatments or in products for sanitizing or disinfecting animal enclosures, pens, watering stations, and veterinary treatment areas such as inspection tables and operation rooms.

In yet other embodiments, the present methods may be employed for reducing the population of pathogenic microorganisms, such as pathogens of humans, animals, and the like. Exemplary pathogenic microorganisms include fungi, molds, bacteria, spores, and viruses, for example, S. aureus, E. coli, Streptococci, Legionella, Pseudomonas aeruginosa, mycobacteria, tuberculosis, phages, or the like.

In yet other embodiments, the present methods may also be used on foods and plant species to reduce surface microbial populations; used at manufacturing or processing sites handling such foods and plant species; or used to treat process waters around such sites. For example, the present methods may be used on food transport lines (e.g., as belt sprays); boot and hand-wash dip-pans; food storage facilities; anti-spoilage air circulation systems; refrigeration and cooler equipment; beverage chillers and warmers, blanchers, cutting boards, third sink areas, and meat chillers or scalding devices. The present methods may be used to treat transport waters such as those found in flumes, pipe transports, cutters, slicers, blanchers, retort systems, washers, and the like. Particular foodstuffs that may be treated with the present methods include eggs, meats, seeds, leaves, fruits and vegetables. Particular plant surfaces include both harvested and growing leaves, roots, seeds, skins or shells, stems, stalks, tubers, corms, fruit, and the like. The present methods may also be used to treat animal carcasses to reduce both pathogenic and non-pathogenic microbial levels.

In yet other embodiments, the present methods may be useful in the cleaning or sanitizing of containers, processing facilities, or equipment in the food service or food processing industries. The present methods may be used on food packaging materials and equipment, including for cold or hot aseptic packaging. Examples of process facilities in which the present methods may be employed include a milk line dairy, a continuous brewing system, food processing lines such as pumpable food systems and beverage lines, etc. Food service wares may be disinfected with the present methods. For example, the present methods may also be used on or in ware wash machines, dishware, bottle washers, bottle chillers, warmers, third sink washers, cutting areas (e.g., water knives, slicers, cutters and saws) and egg washers. Particular treatable surfaces include packaging such as cartons, bottles, films and resins; dish ware such as glasses, plates, utensils, pots and pans; ware wash machines; exposed food preparation area surfaces such as sinks, counters, tables, floors and walls; processing equipment such as tanks, vats, lines, pumps and hoses (e.g., dairy processing equipment for processing milk, cheese, ice cream and other dairy products); and transportation vehicles. Containers include glass bottles, PVC or polyolefin film sacks, cans, polyester, PEN or PET bottles of various volumes (100 ml to 2 liters, etc.), one gallon milk containers, paper board juice or milk containers, etc.

In yet other embodiments, the present methods may also be used on or in other industrial equipment and in other industrial process streams such as heaters, cooling towers, boilers, retort waters, rinse waters, aseptic packaging wash waters, and the like. The present methods may be used to treat microbes and odors in recreational waters such as in pools, spas, recreational flumes and water slides, fountains, and the like.

The present methods may also be employed in cleaning and sanitizing clothing items or fabrics which have become contaminated. The compositions of the present disclosure can be contacted with any contaminated surfaces or items at use temperatures in the range of about 4° C. to 60° C., for a period of time effective to sanitize, disinfect, or sterilize the surface or item. For example, the compositions may be injected into the wash or rinse water of a laundry machine and contacted with contaminated fabric for a time sufficient to sanitize the fabric. Excess composition may be removed by rinsing or centrifuging the fabric.

### Methods for Treating a Membrane

In yet another aspect, the present disclosure is directed to a method for treating a membrane, which method comprises contacting a membrane with an effective amount of the compositions described herein for a sufficient time to stabilize, reduce and/or remove microbial population in and/or on the treated membrane, or to stabilize, reduce and/or remove the microbial population on the surface e.g., a membrane such as an ultrafiltration membrane (UF) membrane.

The present methods can use any suitable concentration of the compositions disclosed herein. For example, the composition can be used to treat a membrane at a concentration of from about 1 ppm to about 100,000 ppm of the composition, e.g., about 1-2 ppm, 2-3 ppm, 3-4 ppm, 4-5 ppm, 5-6 ppm, 6-7 ppm, 7-8 ppm, 8-9 ppm, 9-10 ppm, 10-15 ppm, 15-20 ppm, 20-25 ppm, or 25-30 ppm, 30-40 ppm, 40-50 ppm, 50-60 ppm, 60-70 ppm, 70-80 ppm, 80-90 ppm, 90-100 ppm, 100-200 ppm, 200-300 ppm, 300-400 ppm, 400-500 ppm, 500-600 ppm, 600-700 ppm, 700-800 ppm, 800-900 ppm, 900-1,000 ppm, 1,000-2,000 ppm, 2,000-3,000 ppm, 3,000-4,000 ppm, 4,000-5,000 ppm, 5,000-6,000 ppm, 6,000-7,000 ppm, 7,000-8,000 ppm, 8,000-9,000 ppm, 9,000-10,000 ppm, 10,000-20,000 ppm, 20,000-30,000 ppm, 30,000-40,000 ppm, 40,000-50,000 ppm, 50,000-60,000 ppm, 60,000-70,000 ppm, 70,000-80,000 ppm, 80,000-90,000 ppm, or 90,000-100,000 ppm.

The present methods can comprise contacting a membrane with an effective amount of the composition for any suitable amount of time. In some embodiments, the present methods can comprise contacting a membrane with an effective amount of the compositions disclosed herein for from about 1 minute to about 10 hours, e.g., about 1 minute, 2 minutes, 3 minutes, 4 minutes, 5 minutes, 6 minutes, 7 minutes, 8 minutes, 9 minutes, 10 minutes, 20 minutes, 30 minutes, 40 minutes, 50 minutes, 1 hour, 2 hours, 3 hours, 4 hours, 5 hours, 6 hours, 7 hours, 8 hours, 9 hours, or 10 hours.

In yet another aspect, the various methods for treatment using the compositions of the disclosure for disinfectant applications, including a hard or a soft health care surface. Exemplary surfaces include any instrument, including medical or dental instruments or devices that can benefit from cleaning with a composition according to the present disclosure. Particularly suitable instruments include, but are not limited to diagnostic instruments, scopes (e.g., endoscopes, stethoscopes, and arthroscopes) and related equipment, and the like, or combinations thereof.

The present methods of use on a health care surface can use any suitable concentration of the compositions. For example, the composition can be used at a concentration of from about 1 ppm to about 100,000 ppm of the composition, e.g., about 1-2 ppm, 2-3 ppm, 3-4 ppm, 4-5 ppm, 5-6 ppm, 6-7 ppm, 7-8 ppm, 8-9 ppm, 9-10 ppm, 10-15 ppm, 15-20 ppm, 20-25 ppm, or 25-30 ppm, 30-40 ppm, 40-50 ppm, 50-60 ppm, 60-70 ppm, 70-80 ppm, 80-90 ppm, 90-100 ppm, 100-200 ppm, 200-300 ppm, 300-400 ppm, 400-500 ppm, 500-600 ppm, 600-700 ppm, 700-800 ppm, 800-900 ppm, 900-1,000 ppm, 1,000-2,000 ppm, 2,000-3,000 ppm, 3,000-4,000 ppm, 4,000-5,000 ppm, 5,000-6,000 ppm, 6,000-7,000 ppm, 7,000-8,000 ppm, 8,000-9,000 ppm, 9,000-10,000 ppm, 10,000-20,000 ppm, 20,000-30,000 ppm, 30,000-40,000 ppm, 40,000-50,000 ppm, 50,000-60,000 ppm, 60,000-70,000 ppm, 70,000-80,000 ppm, 80,000-90,000 ppm, or 90,000-100,000 ppm.

The present methods can comprise contacting a surface with an effective amount of the compositions for any suitable amount of time. In some embodiments, the present methods can comprise contacting a surface with an effective amount of the compositions for from about 1 minute to about an hour, e.g., about 1 minute, 2 minutes, 3 minutes, 4 minutes, 5 minutes, 6 minutes, 7 minutes, 8 minutes, 9 minutes, or 10 minutes or greater. In an aspect, the contacting time is preferably less than 10 minutes, and more preferably less than 5 minutes.

### Methods for Treating a Target or Surface Using a Wipe

In yet another aspect, the various methods for treatment using the compositions disclosed herein can be delivered using a saturated wipe and/or provided as a spray to be used with a wipe substrate.

Disposable substrates are commonly used in cleaning applications. Suitable substrates include woven and nonwoven fabrics, including porous or absorbent fabrics, and various combinations thereof. Such substrates can be impregnated with the compositions according to the disclosure. The resulting disinfecting products fabricated from such impregnated substrates are accepted as a convenient and practical means for cleaning surfaces.

The term “wipe composition” refers to a wipe substrate saturated with the RTU solution or where the RTU solution is sprayed onto a surface (then contacted with the wipe) or the wipe. Cellulosic fibers can include plant-based fibers that are natural fibers (also referred to as regenerative fibers). Examples of cellulosic fiber include pulp fibers, cellulose fibers and regenerated cellulose fibers (e.g., viscose or also referred to as rayon, and lyocell or also referred to as tencel). Pulp fibers are smaller, shorter fibers. Regenerated fibers are pulp that are prepared, dissolved, and extruded (i.e., reprocessed) to create longer fibers or a continuous fiber, where beneficially the chemical nature of the derivative is retained after the fiber formation process.

The wipe substrates referred to herein include cellulosic and modified cellulose fibers comprising lyocell and viscose, which is understood to include regenerative cellulose fibers comprising lyocell and viscose. Both viscose and lyocell are stronger than pulp. However, lyocell is known to be a stronger material than viscose due to its more uniform geometry and production method.

In preferred embodiments, the wipe substrate is derived from cellulosic fibers and comprises, consists of, or consists essentially of lyocell and viscose. Viscose is a treated pulp or cellulose fiber, such as treated with sodium hydroxide and carbon disulfide. Lyocell fibers are solvent extruded for increased mobility and alignment of the fiber chains, enhancing the crystalline character. Functionally this means that lyocell maintains its strength when wet, whereas viscose loses strength when wet. They are both renewable fibers that are commercially available in nonwoven forms from numerous suppliers. Both renewable fibers lyocell and viscose can have varying diameter, shape, elastic modulus, tensile strength and failure strain that is tunable during the fiber production.

In certain embodiments, the wipe substrate is made up of at least 50%, at least 60%, at least 70%, at least 80%, at least 90%, at least 95%, or 100% of the cellulosic fibers comprising lyocell and viscose. In preferred embodiments, the wipe substrate is made up of at least 90%, at least 95%, or 100% of the cellulosic fibers comprising lyocell and viscose. In embodiments, the wipe substrate is made up of about 100% of the cellulosic fibers lyocell and viscose.

In certain embodiments, the wipe substrate is substantially free or free of thermoplastic fibers and polymers, namely petrochemically derived thermoplastic fibers and polymers including for example, polypropylene (PP), polyvinyl chloride (PVC), polyethylene (PE), polyesters, including polyethylene terephthalate (PET), polyethers, polyacrylics, polyamides, polyesteramides, polyvinylalcohols, polystyrenes, and the like. In an embodiment, the wipe substrate and wipe composition are substantially free or free of synthetic fibers.

In embodiments, the substrate wipe is a nonwoven substrate. Nonwoven substrates can be formed by any suitable technique as readily apparent to those of skill in the art, including for example where fibers are interlaid (often in a non-identifiable manner, i.e., nonwoven). Known techniques include for example, meltblown, spunbond, spunlaid, SMS (spunbond-meltblown-spunbond), co-formed, carded webs, thermal bonded, thermoformed, spunlace, hydroentangled, hydroembossed, needled, or chemically bonded. In embodiments where multiple layers of the fibers are used, they may be bonded through any suitable technique as readily apparent to those of skill in the art, including for example hydroentangling. In an embodiment the wipe compositions comprise spunlace or hydroentangled cellulose or modified cellulose fibers.

The wipe substrates described herein can also take various shapes and sizes, which are not intended to limit the scope of the disclosure herein. For example, wipes can include a single sheet of material, layers of material (e.g., 2 or more layers), material designed to conform to a particular shape, material suitable for affixing to a cleaning apparatus or implement (e.g., cleaning tool). Most commonly the substrate is in the form of a wipe.

In embodiments, the wipe is a single or multi-use substrate. In some embodiments, beneficially the wipe compositions even when provided as single-use compositions are biodegradable or compostable.

The fibers have a basis weight (referring to the individual layers of the wipe substrate) measured in grams per square meter (GSM). In some embodiments the basis weight of the wipe substrate derived from cellulosic fibers is about 1 to about 200 GSM, or from about 20 to about 60 GSM. Exemplary nonwoven substrates are described in U.S. Patent Publication 2012/066852 and U.S. Patent Publication 2011/244199.

In an embodiment, microfiber products are used herein for the delivery of the wipe compositions, such as those constructed from split conjugated fibers of polyester and polyamide, or alternatively polyamide free versions. In an aspect, the composition is used to coat the substrate for contacting a surface. The compositions coated onto the substrate may optionally further include one or more additives such as fragrances, dyes, pigments, emollients, bleaching agents, anti-static agents, anti-wrinkling agents, odor removal/odor capturing agents, ultraviolet light protection agents, insect repellency agents, souring agents, mildew removing agents, allergicide agents, and mixtures thereof.

In an embodiment, wipe composition is saturated, meaning the liquid concentrate or a RTU composition is saturated onto the wipe substrate. In such an embodiment, the compositions described herein are coated onto the substrate for length of times from about 20 seconds, 30 seconds, 45 seconds, 1 minute, 2 minutes, 5 minutes, 10 minutes and up to about 7 days. Pre-coated wipes may be sold in airtight containers. Such pre-coated wipes may be in contact with the disinfectant for seconds, to hours to days, and preferably weeks. In other embodiments, the compositions are provided as a spray, providing a liquid composition, that is in contact with a wipe substrate at a point of use and wiped onto a surface.

The wipe compositions may be packaged in a variety of convenient containers or container systems. In embodiments the wipe substrates (for later contacting the use solution or RTU solution) may also be packaged the containers or container systems. In embodiments, the container or container system includes a vessel or container for storage and dispensing, such as a flowpack container including a flexible film with wipe stack contained therein. In preferred embodiments the container or container system includes a lid to reduce spillage and/or evaporation of the sanitizing or disinfecting composition. In preferred embodiments the container or container system has a lid that allows the wipes to be pulled through an opening of the container that causes minimal leakage and no tearing of the wipe substrate. Preferably the wipes are packaged in rolls, stacks or piles made up of any number of wipes. Typically, the container or container system houses from 10 to about 500 wipes. In embodiments, the wipe substrate may be perforated into individual use sizes that can be easily removed from the container or container system by a user.

The wipe compositions are particularly well suited for treating surfaces in need of cleaning, sanitizing and/or antimicrobial efficacy. In further aspects, the wipe compositions are still further well suited for treating surfaces in need of antimicrobial efficacy without the use of any quaternary ammonium compounds and/or anionic surfactants having regulatory limitations. In a particular aspect, the wipe compositions are particularly well suited for providing efficacy against microbial pathogens while providing surface compatible formulations that are not corrosive and do not require PPE. In preferred embodiments the wipe compositions are surface compatible and non-corrosive that do not require PPE for use as they preferably provide the RTU composition having a pH between about 4 to about 5.5, or preferably between about 4.5 and about 5.5.

The methods of use include a contacting step, wherein the wipe compositions are applied to a surface in need of treatment. Such surfaces in need of treatment may be hard surfaces having soils and/or soil residues or other undesirable appearances. In an aspect, contacting the wipe composition to such surfaces is intended to remove such soils and/or soil residues or other undesirable appearances while maintaining a food safe contact surface that does not require a rinsing step. This beneficially provides a sanitizing result for the surface in need of treatment.

In other aspects, contacting the wipe composition is to a surface contaminated with a pathogen, namely a bacterial pathogen. In a further aspect, the methods provide greater than a 99% reduction (2-log order reduction) in such population, greater than a 99.9% reduction (3-log order reduction) in such population, greater than 99.99% reduction (4-log order reduction) in such populations, or greater than a 99.999% reduction (5-log order reduction) in the population on a surface.

In a further aspect, contacting the wipe composition can be to a food contact and/or non-food contact hard surface. Surfaces can also include those cleaned in third-sink sanitizing, including various wares.

The various surfaces to which the compositions can be applied can include any conventional application means. Application can include, for example, by wiping, spraying and wiping, dipping or otherwise immersing and then wiping, or the like. In an embodiment, applications can include a wipe that is saturated with the wipe composition.

In an embodiment, the methods can include a first step of saturating, loading, impregnating, or dosing a wipe or substrate with the use solution of the wipe composition or a RTU composition. In an aspect, the use solution of the wipe composition is used to saturate the substrate for contacting a surface creating a saturated wipe. In a further aspect, the use solution of the wipe composition saturated wipe is used to contact a surface that has soils and/or contamination.

The contacting step allows the composition to contact the surface in need of treatment for a predetermined amount of time. The amount of time can be sufficient to allow, including from a few seconds to a few minutes, or any range therebetween. The methods may comprise a single step of applying the composition onto the surface, i.e. a wiping step. Beneficially, in various embodiments the compositions can optionally provide a no-rinse application.

Temperature conditions for the methods can range from about 40° F.-160° F., about 60° F.-140° F., or about 70° F.-140° F. In general, the temperature conditions are not meant to limit application of use of the compositions as described in the methods herein.

Beneficially, the methods do not require a rinse step. In an aspect, the compositions are food contact approved and do not require a rinse step. As a further benefit, the methods do not cause corrosion and/or interfere with surfaces (e.g., hazy, dull or other negative aesthetic effects on the surface).

In embodiments, the wipe compositions meet bactericidal requirements for EN1276 (bacterial suspension study), EN13697 (bacteria-carrier based study), and EN16615 (bacteria-carrier based study) at 18° C.-25° C. under clean and/or dirty conditions. In embodiments, the wipe compositions meet virucidal requirements for EN14476 at 18° C.-25° C. under clean and/or dirty conditions. As one skilled in the art will appreciate, the suspension studies can also be referred to as Phase 2, Step 1 (or 2.1-suspension) studies and the carrier studies can also be referred to as Phase 2, Step 2 (or 2.2-carrier) studies or also laboratory simulated surface tests.

### EMBODIMENTS

The present disclosure is further defined by the following numbered embodiments:

1. A method of use for providing surface cleaning, sanitizing and/or disinfecting comprising: (a) contacting a surface in need of cleaning, sanitizing and/or disinfecting with an acidic antimicrobial composition comprising: (i) an alkyl amine oxide according to the structure:

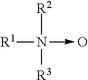

wherein R1, R2, and R3 are independently selected from saturated or unsaturated and straight or branched alkyl groups or aromatic groups having from 1-24 carbons; (ii) an acidulant comprising an inorganic acid, organic acid, or a combination thereof; (iii) optionally a drying agent comprising an alcohol; and (iv) water; (b) wherein the acidic antimicrobial composition achieves at least a 1-log microbial reduction or at least a 3-log microbial reduction in 5 minutes or less in an in vitro assay; wherein the pH of the use solution of the acidic antimicrobial composition is between about 3.5 to about 5.5, or wherein the pH of the RTU acidic antimicrobial composition is between about 4 to about 5.5, or preferably between about 4.5 and about 5.5.

2. The method of embodiment 1, wherein the alkyl amine oxide with R1 is a C8-C16 alkyl group, or preferably a C12-C16 alkyl group, and R2 and R3 are both CH3.

3. The method of any one of embodiments 1-2, wherein the amine oxide is (a) an alkyl dimethyl amine oxide, (b) an octyl, decyl, dodecyl, isododecyl, or (c) a dimethyl amine oxide that is a lauryl dimethyl amine oxide, myristyl dimethyl amine oxide, palmitic dimethyl amine oxide, or a combination thereof.

4. The method of any one of embodiments 1-3, wherein the acidulant comprises a carboxylic acid, polycarboxylic acid, or a salt thereof.

5. The method of any one of embodiments 1-4, wherein the drying agent comprises methanol, ethanol, propanol, isopropanol, butanol, isobutanol, 2-butoxyethanol, 1-decanol, benzyl alcohol, or combinations thereof, or preferably comprises ethanol, isopropanol or combinations thereof.

6. The method of any one of embodiments 1-5, wherein the amine oxide comprises from about 8 wt-% to about 50 wt-%, or from about 10 wt-% to about 45 wt-% of the composition, and/or wherein the acidulent comprises from about 1 wt-% to about 20 wt-%, or from about 10 wt-% to about 20 wt-% of the composition.

7. The method of any one of embodiments 1-6, wherein the acidic antimicrobial composition further comprises a buffer, a defoaming agent, a propellant, an additional antimicrobial active, fragrance, dye or combination thereof.

8. The method of any one of embodiments 1-7, wherein the contacting is wiping a surface with a substrate either saturated with or sprayed with a ready-to-use (RTU) dilution of the acidic antimicrobial composition.

9. The method of embodiment 8, wherein the amine oxide comprises from about 0.01 wt-% to about 10 wt-%, or from about 0.01 wt-% to about 1 wt-%, optionally wherein the drying agent comprises from about 1 wt-% to about 15 wt-%, or from about 1 wt-% to about 10 wt-%, and/or wherein the acidulent comprises from about 0.1 wt-% to about 10 wt-%, or from about 0.1 wt-% to about 5 wt-% of the RTU composition.

10. The method of any one of embodiments 1-9, wherein the acidic antimicrobial composition (a) has at least about 75%, at least about 80%, at least about 85%, or at least about 90% reduction in the concentration of quaternary ammonium compounds, oxidizing chemistries, and/or disinfectants compared to an antimicrobial composition that does not include the alkyl amine oxide and the acidulent; or (b) has less than about 20 wt-%, 10 wt-%, 5 wt-% or 1 wt-% of quaternary ammonium compounds, oxidizing chemistries, and/or disinfectants in the acidic antimicrobial composition; or (c) has less than about 1 wt-%, 0.5 wt-%, 0.1 wt-% of quaternary ammonium compounds, oxidizing chemistries, and/or disinfectants in the RTU of the acidic antimicrobial composition.

11. The method of any one of embodiments 1-9, wherein the acidic antimicrobial composition is substantially free or is free of quaternary ammonium compounds, anionic surfactants, oxidizing chemistries, disinfectants, and/or N-alkylpyrrolidones or derivatives thereof.

12. The method of any one of embodiments 1-11, wherein the 3-log microbial reduction in 5 minutes or less in an in vitro assay against Klebsiella aerogenes or Staphylococcus aureus for non-food contact surface sanitizing according to ASTM E1153.

13. The method of any one of embodiments 1-11, wherein the method achieves a 5-log microbial reduction in 30 seconds or less in an in vitro assay against Staphylococcus aureus and/or Escherichia coli for food contact surface sanitizing according to AOAC Method 960.09.

14. The method of any one of embodiments 1-11, wherein the method achieves at least a 1-log reduction of a non-pathogenic organism according to AOAC Method 960.09, and/or wherein the method provides disinfection of a treated surface.

15. The method of any one of embodiments 1-11, wherein the method achieves at least a 3-log order reduction of viruses on a surface or substrate within 5 minutes in an in vitro assay according to one of the following standards: ASTM E1053 Standard Test Method for Efficacy of Virucidal Agents Intended for Inanimate Environmental Surfaces; EPA 810.2200; or EN 14476.

16. The method of any one of embodiments 1-15, wherein the surface is a hard surface and comprises a metal in need of low corrosivity.

17. The method of embodiment 16, wherein the hard surface is located within a food or beverage manufacturing facility or on farm premises, or wherein the hard surface is located within a food or beverage manufacturing facility surface is a processing surface, a food preparation surface, a surface in a restaurant, a surface in a grocery store, a household surface, a drive-thru surface, and/or a hard surface comprising food soils, and wherein the surface located on farm premises is a device, apparatus, machine, pipe, hose, conduit, tube, nozzle, sprayer, carousel, shaft, cavity, container, vat, or rail used in a farm process or production of a farm product.

18. The method of any one of embodiments 1-17, wherein the surface is a soft and/or porous surface, and preferably comprises a textile, laundry substrate, or a membrane.

19. The method of any one of embodiments 1-18, wherein the method further comprises rinsing the surface.

20. The method of any one of embodiments 1-19, wherein the antimicrobial composition is a concentrate the method further comprises a first step of generating a use solution of the antimicrobial composition before contacting the surface, and wherein the use solution is generated with a water source.

21. The method of any one of embodiments 1-20, wherein the method further comprises discharging the composition into a wastewater system, and wherein the antimicrobial composition is biodegradable and does not pose risk to the wastewater system.

22. A concentrate or ready-to-use (RTU) acidic antimicrobial composition comprising: (i) an alkyl amine oxide according to the structure:

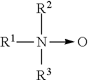

wherein R1, R2, and R3 are independently selected from saturated or unsaturated and straight or branched alkyl groups or aromatic groups having from 1-24 carbons; (ii) an acidulant comprising an inorganic acid, organic acid, or a combination thereof; (iii) optionally a drying agent comprising an alcohol; and (iv) water, wherein the pH of the concentrate composition is between about 3.5 to about 5.5, or wherein the pH of the RTU acidic antimicrobial composition is between about 4 to about 5.5, or preferably from about 4.5 to about 5.5, and wherein the RTU acidic antimicrobial composition is optionally saturated on a wipe substrate.

23. The composition of embodiment 22, wherein the alkyl amine oxide is a dimethyl alkyl amine oxide wherein R1 is a C8-C16 alkyl group, and R2 and R3 are both CH3.

24. The composition of any one of embodiments 22 or 23, wherein the amine oxide is (a) an alkyl dimethyl amine oxide, (b) an octyl, decyl, dodecyl, isododecyl, or (c) a dimethyl amine oxide that is a lauryl dimethyl amine oxide, myristyl dimethyl amine oxide, palmitic dimethyl amine oxide, or combinations thereof.

25. The composition of any one of embodiments 22-24, wherein the acidulant comprises a carboxylic acid, polycarboxylic acid or salt thereof.

26. The composition of any one of embodiments 22-25, wherein the drying agent comprises methanol, ethanol, propanol, isopropanol, butanol, isobutanol, 2-butoxyethanol, 1-decanol, benzyl alcohol, or combinations thereof, or preferably comprises ethanol, isopropanol or combinations thereof.

27. The composition of any one of embodiments 22-26, wherein the amine oxide comprises from about 8 wt-% to about 50 wt-%, or from about 10 wt-% to about 45 wt-% of the concentrate composition, and wherein the acidulent comprises from about 1 wt-% to about 20 wt-%, or from about 10 wt-% to about 10 wt-% of the concentrate composition, or wherein the amine oxide comprises from about 0.01 wt-% to about 10 wt-%, or from about 0.01 wt-% to about 1 wt-% of the RTU composition, optionally wherein when the drying agent is present comprises from about 1 wt-% to about 15 wt-%, or from about 1 wt-% to about 10 wt-%, and wherein the acidulent comprises from about 0.1 wt-% toa bout 10 wt-%, or from about 0.1 wt-% to about 5 wt-% of the RTU composition.

28. The composition of any one of embodiments 22-27, further comprising a defoaming agent, propellant, additional antimicrobial active, or a combination thereof.

29. The composition of any one of embodiments 22-28, wherein the antimicrobial composition (a) has at least about 75%, at least about 80%, at least about 85%, or at least about 90% reduction in the concentration of quaternary ammonium compounds, oxidizing chemistries, and disinfectants compared to an antimicrobial composition that does not include the alkyl amine oxide and the acidulent; or (b) has less than about 20 wt-%, 10 wt-%, 5 wt-% or 1 wt-% of quaternary ammonium compounds, oxidizing chemistries, and/or disinfectants in the acidic antimicrobial composition; or (c) has less than about 1 wt-%, 0.5 wt-%, or 0.1 wt-% of quaternary ammonium compounds, oxidizing chemistries, and disinfectants in the RTU of the antimicrobial composition.

30. The composition of any one of embodiments 22-29, wherein the composition is substantially free of quaternary ammonium compounds, anionic surfactants, oxidizing chemistries, disinfectants, and/or N-alkylpyrrolidones or derivatives thereof.

31. The composition of any one of embodiments 22-30, wherein the composition is free of quaternary ammonium compounds, anionic surfactants, oxidizing chemistries, and/or disinfectants, and/or N-alkylpyrrolidones or derivatives thereof.

32. The composition of any one of embodiments 22-31, wherein the composition is a non-oxidizing, low toxicity and low corrosivity composition.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

The following antimicrobial compositions comprising amine oxides and carboxylic acids were tested in the Examples below:

TABLE 2

| | Antimicrobial compositions | | | | | | | | | | | |
|---|---|---|---|---|---|---|---|---|---|---|---|---|
| Component | 1 | | 2 | | 3 | | 4 | | 5 | | 6 | |
| Dodecydimethyl | <1 | wt-% | <1 | wt-% | <1 | wt-% | 20-25 | wt-% | 20-25 | wt-% | 40-45 | wt-% |
| AO (30%) | | | | | | | | | | | | |
| Barlox 12 (30%) | 20-25 | wt-% | 20-25 | wt-% | 40-45 | wt-% | <1 | wt-% | <1 | wt-% | <1 | wt-% |
| Nonanoic Acid | <1 | wt-% | 1-2 | wt-% | <1 | wt-% | <1 | wt-% | 1-2 | wt-% | <1 | wt-% |
| Glacial acetic | 13-19 | wt-% | 13-19 | wt-% | 13-19 | wt-% | 13-19 | wt-% | 13-19 | wt-% | 13-19 | wt-% |
| acid | | | | | | | | | | | | |
| DI Water | 60-65 | wt-% | 60-65 | wt-% | 40-45 | wt-% | 60-65 | wt-% | 60-65 | wt-% | 40-45 | wt-% |
| Total | 100 | wt-% | 100 | wt-% | 100 | wt-% | 100 | wt-% | 100 | wt-% | 100 | wt-% |
| Use Dilution | 0.52 | oz/g | 0.52 | oz/g | 0.52 | oz/g | 0.52 | oz/g | 0.52 | oz/g | 0.52 | oz/g |

| | | | | | | |
|---|---|---|---|---|---|---|
| pH in 5 G water | 4.30 | 4.25 | 4.39 | 4.30 | 4.26 | 4.38 |
| at 0.4% | | | | | | |
| pH in 17 G of | 4.86 | 4.83 | 4.93 | 4.85 | 4.84 | 4.92 |
| water at 0.4% | | | | | | |

TABLE 3

| | Antimicrobial compositions | | | | | | | | | |
|---|---|---|---|---|---|---|---|---|---|---|
| Component | 7 | | 8 | | 9 | | 10 | | 11 | |
| Dodecydimethyl | <1 | wt-% | <1 | wt-% | 10-15 | wt-% | 10-15 | wt-% | <1 | wt-% |
| AO (30%) | | | | | | | | | | |
| Barlox 12 (30%) | 10-15 | wt-% | 10-15 | wt-% | <1 | wt-% | <1 | wt-% | 65-70 | wt-% |
| Nonanoic Acid | <1 | wt-% | 0.5-1.5 | wt-% | <1 | wt-% | 0.5-1.5 | wt-% | <1 | wt-% |
| Glacial acetic | 13-19 | wt-% | 13-19 | wt-% | 13-19 | wt-% | 13-19 | wt-% | 13-19 | wt-% |
| acid | | | | | | | | | | |
| DI Water | 70-75 | wt-% | 70-75 | wt-% | 70-75 | wt-% | 70-75 | wt-% | 15-18 | wt-% |
| Total | 100 | wt-% | 100 | wt-% | 100 | wt-% | 100 | wt-% | 100 | wt-% |
| Use Dilution | 0.52 | oz/g | 0.52 | oz/g | 0.52 | oz/g | 0.52 | oz/g | 0.52 | oz/g |

The following materials were also used in the antimicrobial compositions utilized in the Examples:

Barlox 12 (active): Cocoamine oxide including a blend of lauric, myristyl, palmitic and lower levels of C8, C10, and oleyl-amine oxides.

Active: Amine Oxides: C10, C12, C14, and C16.

Active: Pelargonic acid.

Acidulent, buffer: Acetic acid.

Active: Lactic acid.

Acidulent, buffer: Malic acid.

### Organic Acids: Citric Acid, Monosodium Citrate, Adipic, Fumaric Acid.

Drying Agent: ethanol.

The microorganisms tested included: Staphylococcus aureus, Klebsiella aerogenes and Escherichia coli.

### Example 1

The antimicrobial efficacy of an amine oxide (Barlox 12) was tested with two different microorganisms, S. aureus and E. coli., at various pH levels. Specifically, the testing conducted was to assess food contact sanitization using solely the amine oxide at a certain pH. The testing conducted required 5-log reduction in 30 seconds for both microorganisms tested in order for the result to be deemed passing.

The Food Contact Sanitizer test method (Germicidal & Detergent Sanitizing Action of Disinfectants, AOAC Method 960.09) was utilized to evaluate antimicrobial efficacy with the amine oxide with both microorganisms.

Two separate nutrient agars, nutrient agar A and nutrient agar B, were prepared for testing and used for growing test cultures. A tryptone glucose extract agar was utilized as the recovery media. A neutralizer broth was prepared, as well as Phosphate Buffered Saline (PBS)+0.1% Tween 80, phosphate buffer dilution water (PBDW) and both testing organisms including Escherichia coli (ATCC 11229) and Staphylococcus aureus (ATCC 6538).

Both test organisms were incubated throughout testing at 35±2° C. as per AOAC Method 960.09.

In order to prepare the culture suspensions for evaluating the antimicrobial efficacy, a thawed frozen stock culture of each microorganism tested was inoculated onto a Nutrient Agar A slant and allowed to incubate at 35±2° C. for 24±2 hours.

The final test culture was prepared by adding 5 mL of PBDW to the inoculated slant and dislodging growth from the agar surface. The mixture was collected and added to the balance of 99 mL of PBDW and mixed. A sufficient number of Nutrient Agar B agar plates were inoculated with the suspension to create a bacterial lawn. Plates were incubated at 35±2° C. for 24±2 hours. Following incubation, test organisms were harvested from agar plates by adding an appropriate amount of PBS+Tween 80 to the plates and gently dislodging the culture from the surface. Recovered culture from each plate was combined, mixed and filtered through sterile Whatman No. 2 filter paper. The suspension was adjusted, as necessary with PBDW, to target approximately 1.0×10⁹-1.0×10¹⁰ organisms per milliliter for use in efficacy testing.

Efficacy testing was performed by adding 99 mL of prepared test solution into sterile 250 mL Erlenmeyer flasks. Prepared test flasks were allowed to equilibrate at 25±1° C. in a water bath for a minimum of 10 minutes. Following equilibration, test flasks were swirled, creating enough residual motion to prevent pooling of the test organism, and 1 mL of the prepared test organism suspension was added while the liquid was still in motion. Test flasks were returned to the water bath for treatment exposure. Following completion of the 30 second exposure time, a 1 mL portion of the test solution was transferred to 9 mL of neutralizing broth and mixed well.

A corresponding Numbers Control was performed during testing by adding 1 mL of the prepared test organism suspension to 99 mL of PBDW equilibrated to 25±1° C., as performed in the efficacy test procedure, to ensure the control target of 7.0-8.0 Log₁₀ density was achieved for each test organism. Following a 30 second exposure time, a 1 mL aliquot was sampled and added to 9 mL of neutralizing broth as in the efficacy test.

Following neutralization, each sample was mixed well, serially diluted in PBDW (as needed) and spread plated onto tryptone glucose extract agar for recovery. Plates were allowed to incubate at 35±2° C. for 24-48 hours.

Following incubation, the plates were counted for survivors. Recovery between the efficacy test plates and number control plates were compared to calculate percent and Log₁₀ results.

As shown below in Tables 4-6, the two microorganisms were tested using this protocol at various pH levels and amine oxide concentrations. The results that were deemed passing were those over 5 log reduction for each microorganism.

The first set of testing was conducted with amine oxide at a concentration of 500 ppm or 1350 ppm, with various pH ranges in order to assess the efficacy of using solely amine oxide against both S. aureus and E. coli in food contact sanitization.

TABLE 4

| | | | Log reduction | Log reduction |
|---|---|---|---|---|
| Test substance | pH | Exposure time | S. aureus | E. coli |
| 500 ppm | 2.5 | 30 seconds | 2.76 | 4.35 |
| Cocoamine oxide | | | | |
| 500 ppm | 3.5 | 30 seconds | 2.38 | 6.47 |
| Cocoamine oxide | | | | |
| 500 ppm | 4.0 | 30 seconds | >6.81 | >6.96 |
| Cocoamine oxide | | | | |
| 500 ppm | 4.5 | 30 seconds | >6.81 | >6.96 |
| Cocoamine oxide | | | | |
| 500 ppm | 5.0 | 30 seconds | >6.81 | >6.96 |
| Cocoamine oxide | | | | |
| 500 ppm | 5.5 | 30 seconds | >7.15 | <0.62 |
| Cocoamine oxide | | | | |
| 500 ppm | 6.5 | 30 seconds | 1.27 | <0.62 |
| Cocoamine oxide | | | | |
| 1350 ppm | 2.5 | 30 seconds | 2.71 | >6.95 |
| Cocoamine oxide | | | | |
| 1350 ppm | 3.5 | 30 seconds | 2.56 | >6.95 |
| Cocoamine oxide | | | | |
| 1350 ppm | 4.5 | 30 seconds | 5.29 | >6.95 |
| Cocoamine oxide | | | | |
| 1350 ppm | 6.5 | 30 seconds | 2.02 | <0.62 |
| Cocoamine oxide | | | | |
| 1350 ppm | 7.5 | 30 seconds | 1.00 | <0.62 |
| Cocoamine oxide | | | | |

Table 4 demonstrates that with 500 ppm of amine oxide present, S. aureus and E. coli, the best results were when the pH was 3.5 or higher. However, when 1350 ppm of amine oxide was present, the best results were obtained when testing S. aureus with a pH of 4.5. Increasing the pH even at a higher concentration of the amine oxide of 1350 ppm did not provide increased benefits. Whereas the log reduction for E. coli was consistently above 5, indicating passing results regardless of pH level.

The second set of testing tested 4 different concentrations of active amine oxide at various pH ranges, now 4.5-8.5 to assess the efficacy the efficacy of using solely amine oxide against both S. aureus and E. coli in food contact sanitization.

TABLE 5

| | | | Log reduction | Log reduction |
|---|---|---|---|---|
| Test substance | pH | Exposure time | S. aureus | E. coli |
| 125 ppm | 4.5 | 30 seconds | 6.55 | 2.72 |
| Cocoamine oxide | | | | |
| 150 ppm | 4.5 | 30 seconds | >7.15 | 3.80 |
| Cocoamine oxide | | | | |
| 250 ppm | 4.5 | 30 seconds | >6.81 | >6.96 |
| Cocoamine oxide | | | | |
| 500 ppm | 5.5 | 30 seconds | >7.15 | <0.62 |
| Cocoamine oxide | | | | |
| 500 ppm | 6.5 | 30 seconds | 1.27 | <0.62 |
| Cocoamine oxide | | | | |
| 1350 ppm | 5.5 | 30 seconds | >7.15 | <0.62 |
| Cocoamine oxide | | | | |
| 1350 ppm | 6.5 | 30 seconds | 2.02 | <0.62 |
| Cocoamine oxide | | | | |
| 1350 ppm | 7.5 | 30 seconds | 1.00 | <0.62 |
| Cocoamine oxide | | | | |
| 1350 ppm | 8.5 | 30 seconds | 1.92 | <0.62 |
| Cocoamine oxide | | | | |

The data in Table 5 indicated that the only passing results for log reduction were obtained with S. aureus when the pH ranged from 4.5-5.5 regardless of concentration used. However, none of the data revealed passing results for E. coli regardless of the concentration of amine oxide present or the pH range. Therefore, the results indicate that the pH range of 4.5-5.5 still yield passing results of log reduction of S. aureus.

The third set of testing included testing various amine oxides ranging from C8-C16 each at a concentration of 500 ppm at various pH ranges from 4.5-5.5 against both microorganisms.

TABLE 6

| | | | Log reduction | Log reduction |
|---|---|---|---|---|
| Sample | pH | Exposure time | E. coli | S. aureus |
| 500 ppm Amine | 4.5 | 30 seconds | 1.12 | 1.10 |
| Oxide C8 | | | | |
| 500 ppm Amine | 5.0 | 30 seconds | 1.14 | 1.08 |
| Oxide C8 | | | | |
| 500 ppm Amine | 4.5 | 30 seconds | 5.59 | 4.55 |
| Oxide C10 | | | | |
| 500 ppm Amine | 5.0 | 30 seconds | 5.11 | 3.30 |
| Oxide C10 | | | | |
| 500 ppm Amine | 5.5 | 30 seconds | 1.27 | 3.12 |
| Oxide C10 | | | | |
| 500 ppm Amine | 4.5 | 30 seconds | 6.75 | 6.70 |
| Oxide C12 | | | | |
| 500 ppm Amine | 5.0 | 30 seconds | 6.75 | 6.70 |
| Oxide C12 | | | | |
| 500 ppm Amine | 5.5 | 30 seconds | 2.40 | 5.96 |
| Oxide C12 | | | | |
| 500 ppm Amine | 4.5 | 30 seconds | 6.75 | 6.70 |
| Oxide C14 | | | | |
| 500 ppm Amine | 5.0 | 30 seconds | 6.49 | 6.70 |
| Oxide C14 | | | | |
| 500 ppm Amine | 5.5 | 30 seconds | 1.27 | 4.35 |
| Oxide C14 | | | | |
| 500 ppm Amine | 4.5 | 30 seconds | 1.27 | 3.65 |
| Oxide C16 | | | | |
| 500 ppm Amine | 5.0 | 30 seconds | 1.27 | 3.30 |
| Oxide C16 | | | | |
| 500 ppm Amine | 5.5 | 30 seconds | 1.27 | 1.22 |
| Oxide C16 | | | | |
| 500 ppm Amine | 4.5 | 30 seconds | 6.75 | 6.70 |
| Acid Blend | | | | |
| C10-C16 | | | | |
| 500 ppm Amine | 5.0 | 30 seconds | 5.24 | 5.25 |
| Acid Blend | | | | |
| C10-C16 | | | | |
| 500 ppm Amine | 5.5 | 30 seconds | 1.27 | 4.43 |
| Acid Blend | | | | |
| C10-C16 | | | | |

The data in Table 6 indicates that the most effective log reduction results for E. coli, were with Amine Oxide C110, Amine Oxide C12, Amine Oxide C14 and Amine Acid Blend from C10-C16, at a pH of 4.5-5.0. The testing conducted with Amine Oxide C16 did not have any passing results of log efficacy indicating that the Amine Oxide of shorter carbon chain lengths, C10-C14 are preferable to attain best results for log reduction of E. coli. Additionally, the pH range of 4.5-5.5 was found to be the most effective for log reduction of E. coli.

Additionally, the results indicate that for S. aureus, the most favorable results were with Amine Oxide C12, Amine Oxide C14, and the Amine Acid Blend of C10-C16. Once again, the Amine Oxide C16 did not obtain any passing results in the log reduction of S. aureus. Once again, the pH range found to be most effective for obtaining passing results was 4.5-5.5. Thus, the data indicates a preference for a pH range of 4.5-5.5 as well as Amine Oxide C10-C12 or the Amine Oxide blend of C10-C16.

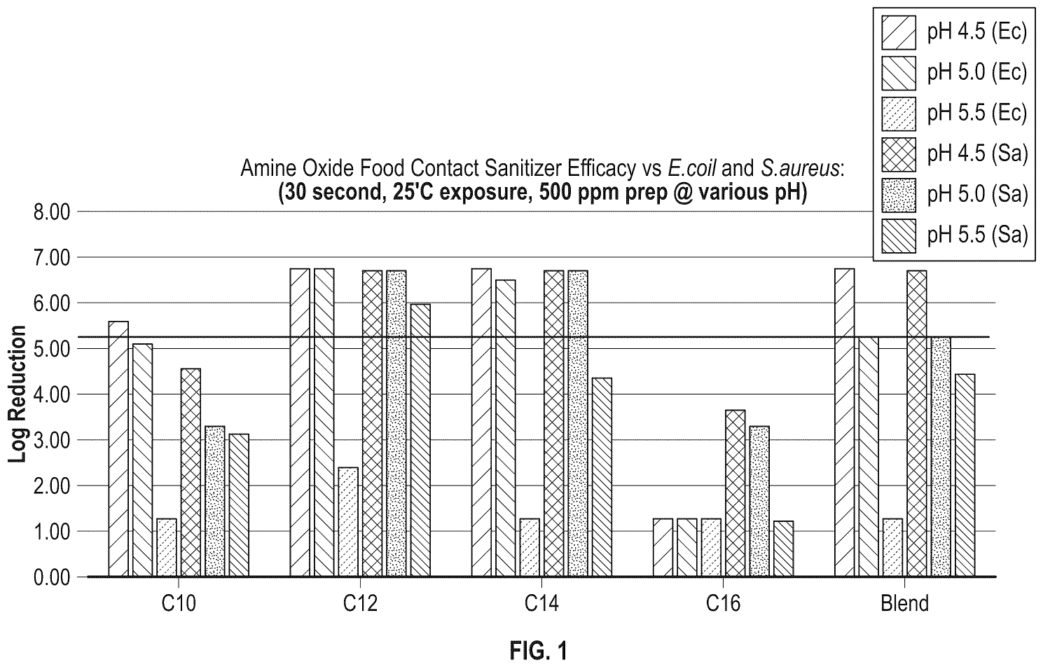

These results are further depicted in the FIG. 1 showing the performance of the mild pH QAC free amine oxide sanitizer with food contact sanitizing efficacy with the 30 second contact, 25° C. exposure and 500 ppm at the varying pH.

### Example 2

The same Food Contact Sanitizing test described in Example 1 was also run on six different antimicrobial compositions. These compositions are antimicrobial compositions 1-6 as shown in Table 2 and antimicrobial compositions 7-10 as shown in Table 3.

Specifically, the testing conducted was to assess the antimicrobial efficacy with food contact sanitization using the antimicrobial compositions shown in Tables 2 and 3 against two microorganisms. The testing conducted required 5-log reduction in 30 seconds for both microorganisms tested in order for the result to be deemed passing.

The Tables 7 and 8 below indicate the results of testing each antimicrobial composition reflected in Tables 2 and 3 utilizing the Food Contact Sanitizer test method as described in Example 1. Each antimicrobial composition was prepared at dilution by 0.40%.

TABLE 7

| Sample (prepared | | Exposure | Average Log Reduction | |
|---|---|---|---|---|
| at 0.40% dilution) | pH | Time | E. coli | S. aureus |
| Antimicrobial | 4.36 | 30 seconds | 6.70 | 6.50 |
| Composition 1 | | | | |
| Antimicrobial | 4.31 | | 6.70 | 6.50 |
| Composition 2 | | | | |
| Antimicrobial | 4.43 | | 6.70 | 6.50 |
| Composition 3 | | | | |
| Antimicrobial | 4.30 | | 6.70 | 6.50 |
| Composition 4 | | | | |
| Antimicrobial | 4.27 | | 5.83 | 5.86 |
| Composition 5 | | | | |
| Antimicrobial | 4.41 | | 6.70 | 6.50 |
| Composition 6 | | | | |

The data in Table 7 reveals that the pH range of 4.27-4.43 with a contact time of 30 seconds achieved above passing results for log reduction of E. coli and S. aureus. The log reduction results for both microorganisms tested were mostly above 5, indicating a passing result for the antimicrobial composition efficacy for food contact sanitizing. Thus, the pH range of 4.27-4.43 used indicates a high rate of antimicrobial compositional efficacy against both E. coli and S. aureus.

TABLE 8

| Sample (prepared at | | | Average Log Reduction | |
|---|---|---|---|---|
| 0.4% dilution) | pH | Contact Time | E. coli | S. aureus |
| Antimicrobial | 4.32 | 30 seconds | 5.1 | 6.64 |
| composition 7 | | | | |
| Antimicrobial | 4.24 | 30 seconds | 6.73 | 5.24 |
| composition 8 | | | | |
| Antimicrobial | 4.27 | 30 seconds | 6.73 | 6.38 |
| composition 9 | | | | |
| Antimicrobial | 4.23 | 30 seconds | 6.73 | 5.41 |
| composition 10 | | | | |

The data in Table 8 shows the results of the same test conducted on antimicrobial compositions 7-10 as reflected in Table 3. Once again, after a contact time of 30 seconds, the pH range of 4.23-4.32 proved to have a high efficacy rate with an above 5 log reduction for E. Coli. Additionally, the average log reduction for S. aureus also remained above a 5 and further bolsters the finding that this pH range appears to be ideal for food contact sanitizing testing for efficacy of these antimicrobial compositions.

### Example 3

The Antimicrobial Composition 1, Antimicrobial Composition 3, and Antimicrobial Composition 7 were then tested for non-food contact sanitization. This test required a 3 log reduction in less than five minutes for each microorganism tested. The two microorganisms tested included K. aerogenes and S. aureus.

The Standard Test Method for Efficacy of Sanitizers Recommended for Inanimate, Hard, Nonporous Non-Food Contact Surfaces (ASTM E1153) was used to conducted testing for the antimicrobial efficacy of sanitizers on precleaned, inanimate, hard nonporous, non-food contact surfaces against K. aerogenes and S. aureus or a combination thereof.

From Nutrient Agar A stock slants, a loopful of culture was transferred to 10 mL of growth medium and incubated for 24±2 hours. K. aerogenes was grown in a Tryptic Soy Broth at 30±2° C. and S. aureus was grown in AOAC Nutrient Broth at 35±2° C. At least 3 consecutive daily transfers were performed prior to use as a test inoculum. The final transfer was incubated for 48 hours to 54 hours and each of these cultures were used for testing.

Following incubation each test organism culture was thoroughly mixed and allowed to settle for 15 minutes. Approximately two-thirds of the suspension was removed and moved to a new tube for use in efficacy testing.

Sterile 1″×1″ glass coupons were inoculated with 0.01 mL to 0.03 mL of the prepared cultures. Each inoculum was spread within approximately 3 mm of the edges of the coupons. A series of test squares were prepared with both K. aerogenes and S. aureus.

Inoculated carriers were placed in a humidity chamber at 35° C. and at constant humidity to dry. The carriers were allowed to remain at this temperature at an appropriate humidity for 20-30 minutes until dry.

Following drying, carriers were transferred to sterile 2 oz. medicine jars with the inoculum facing up. Carriers were treated with 5 mL of the Antimicrobial Compositions as specified in Table 9. Following application, carriers were allowed to expose for the specified amount of time.

Following completion of treatment, 20 mL of a neutralizing broth was added to the jar. The neutralized treated carrier was immediately vortex mixed for 10-15 seconds to suspend any surviving test organisms.

Following neutralization, the neutralized solution was spread plated onto Tryptic Soy Agar to recover any surviving organisms. Test plates were incubated for 48±4 hours at 35±2° C. (S. aureus) or 30±2° C. (K. aerogenes).

In addition to the efficacy test described above, the appropriate Numbers and Neutralization Confirmation Controls were performed as described in the standard test method.

Recovery from treated test coupons was compared to recovery from Number Control coupons to determine a percent and Log Reduction.

TABLE 9

| Sample (All | | | K. aerogenes Percent | | S. aureus Percent | |
|---|---|---|---|---|---|---|
| prepared at | | | (Log) Reduction | | (Log) Reduction | |
| 0.40% | | | 1 minute | 5 minute | 1 minute | 5 minute |
| dilution) | pH | Soil | exposure | exposure | exposure | exposure |
| Antimicrobial | 4.38 | None | 94.6% | 99.99% | 97.5% | 99.87% |
| composition 1 | | | (1.27 Log) | (4.57 Log) | (1.61 Log) | (2.91 Log) |
| | | | Fail | Pass | Fail | Fail |
| Antimicrobial | 4.46 | None | 94.7% | 99.999% | 99.4% | 99.9% |
| composition 3 | | | (1.28 Log) | (5.52 Log) | (2.19 Log) | (3.87 Log) |
| | | | Fail | Pass | Fail | Pass |
| Antimicrobial | 4.54 | None | 99.9% | 99.999% | 99.8% | 99.997% |
| composition 7 | | | (3.73 Log) | (5.52 Log) | (2.65 Log) | (4.01 Log) |
| | | | Pass | Pass | Fail | Pass |

Table 9 demonstrates the results of the non-food contact sanitizing testing for the antimicrobial compositions 1, 3, and 7 when prepared in dilutions at 0.40% against both K. aerogenes and S. aureus. The best results for log reduction of K. aerogenes were obtained at the five minute mark with a 99.999% percent log reduction with each of the antimicrobial compositions tested.

The same was true for S. aureus, where the best results of log reduction was found at five minute mark with a 99.87% log reduction or higher for each of the antimicrobial compositions tested.

Thus, the results indicate that the longer inoculation period with each of the antimicrobial compositions reveals a higher antimicrobial efficacy rate against both K. aerogenes and S. aureus in non-food contact sanitizing testing.

### Example 4

Antimicrobial compositions were evaluated on wipe substrates as summarized in Table 10 on polyether wipe substrates with testing completed in triplicates against gram-positive bacteria S. aureus (which are more challenging for antimicrobial compositions to kill in comparison to gram-negative bacteria, such as E. coli). The gram-positive bacteria was evaluated as the pathogen class is known to have challenges when treating with treatment by amine oxide class of surfactants. It is envisioned that the wipe substrate can be coated with (i.e. pre-saturated) with composition or the composition could alternatively be sprayed onto the wipe or onto a surface to be wiped with the wipe substrate. As referred to herein this Example, the tested antimicrobial compositions were added to the wipe by soaking in the aqueous compositions before use to saturate the wipe.

The tested antimicrobial compositions were compared using 0 ppm to 2000 ppm Barlox 12 as the amine oxide in acidic compositions with and without ethanol added. The results are summarized in Table 11.

TABLE 10

| | | | | | AO C12 |
|---|---|---|---|---|---|
| | | | 10% EtOH | Acetic acid for | concentration |
| Wipe | Carrier | pH | addition | buffer (ppm) | (from Barlox 12) |
| 1 | 1 | 4 | no | 1000 | 0 |
| 1 | 2 | 4 | no | 1000 | 0 |
| 1 | 3 | 4 | no | 1000 | 0 |
| 2 | 4 | 5 | no | 1000 | 0 |
| 2 | 5 | 5 | no | 1000 | 0 |
| 2 | 6 | 5 | no | 1000 | 0 |
| 3 | 7 | 4 | no | 1000 | 200 |
| 3 | 8 | 4 | no | 1000 | 200 |
| 3 | 9 | 4 | no | 1000 | 200 |
| 4 | 10 | 5 | no | 1000 | 200 |
| 4 | 11 | 5 | no | 1000 | 200 |
| 4 | 12 | 5 | no | 1000 | 200 |
| 5 | 13 | 4 | no | 1000 | 1000 |
| 5 | 14 | 4 | no | 1000 | 1000 |
| 5 | 15 | 4 | no | 1000 | 1000 |
| 6 | 16 | 5 | no | 1000 | 1000 |
| 6 | 17 | 5 | no | 1000 | 1000 |
| 6 | 18 | 5 | no | 1000 | 1000 |
| 7 | 19 | 4 | no | 1000 | 2000 |
| 7 | 20 | 4 | no | 1000 | 2000 |
| 7 | 21 | 4 | no | 1000 | 2000 |
| 8 | 22 | 5 | no | 1000 | 2000 |
| 8 | 23 | 5 | no | 1000 | 2000 |
| 8 | 24 | 5 | no | 1000 | 2000 |
| 9 | 25 | 4 | yes | 1000 | 1000 |
| 9 | 26 | 4 | yes | 1000 | 1000 |
| 9 | 27 | 4 | yes | 1000 | 1000 |
| 10 | 28 | 5 | yes | 1000 | 1000 |
| 10 | 29 | 5 | yes | 1000 | 1000 |
| 10 | 30 | 5 | yes | 1000 | 1000 |

TABLE 11

| | | | CFU | | | | | | | |
|---|---|---|---|---|---|---|---|---|---|---|
| | | | Recovered | | | | | | | |
| | | | @ dilution | | | Log | | Geo- | | |
| Wipe | | | plated | | CFU/ | CFU/ | Avg | metric | Log | |
| Sample | pH | Carrier | 1 mL | .1 mL | Carrier | Carrier | Log | Mean | Redct | % Redct |
| 1 - AA | 4 | 1 | TNTC | 56 | 1.12E+04 | 4.05 | 3.84 | 6.93E+03 | 2.25 | 99.438% |
| buffer | | 2 | 126 | 11 | 2.25E+03 | 3.40 | | | | |
| | | 3 | TNTC | 59 | 1.18E+04 | 4.07 | | | | |
| 2 - AA | 5 | 1 | TNTC | 44 | 8.80E+03 | 3.94 | 3.93 | 8.54E+03 | 2.16 | 99.308% |
| buffer | | 2 | TNTC | 34 | 6.80E+03 | 3.83 | | | | |
| | | 3 | TNTC | 52 | 1.04E+04 | 4.02 | | | | |
| 3 - AA | 4 | 1 | 1 | 0 | 2.00E+01 | 1.30 | 1.66 | 4.58E+01 | 4.43 | 99.996% |
| Buffer + | | 2 | 3 | 0 | 6.00E+01 | 1.78 | | | | |
| 200 ppm | | 3 | 4 | 0 | 8.00E+01 | 1.90 | | | | |
| AO | | | | | | | | | | |
| 4 - AA | 5 | 1 | 0 | 0 | 2.00E+01 | 1.30 | 1.50 | 3.17E+01 | 4.59 | 99.997% |
| Buffer + | | 2 | 4 | 0 | 8.00E+01 | 1.90 | | | | |
| 200 ppm | | 3 | 0 | 0 | 2.00E+01 | 1.30 | | | | |
| AO | | | | | | | | | | |
| 5 - AA | 4 | 1 | 0 | 0 | 2.00E+01 | 1.30 | 1.30 | 2.00E+01 | 4.79 | 99.998% |
| Buffer + | | 2 | 0 | 0 | 2.00E+01 | 1.30 | | | | |
| 1000 | | 3 | 1 | 0 | 2.00E+01 | 1.30 | | | | |
| ppm AO | | | | | | | | | | |
| 6 - AA | 5 | 1 | 0 | 0 | 2.00E+01 | 1.30 | 1.30 | 2.00E+01 | 4.79 | 99.998% |
| Buffer + | | 2 | 0 | 0 | 2.00E+01 | 1.30 | | | | |
| 1000 | | 3 | 0 | 0 | 2.00E+01 | 1.30 | | | | |
| ppm AO | | | | | | | | | | |
| 7 - AA | 4 | 1 | 0 | 0 | 2.00E+01 | 1.30 | 1.30 | 2.00E+01 | 4.79 | 99.998% |
| Buffer + | | 2 | 0 | 0 | 2.00E+01 | 1.30 | | | | |
| 2000 | | 3 | 0 | 0 | 2.00E+01 | 1.30 | | | | |
| ppm AO | | | | | | | | | | |
| 8 - AA | 5 | 1 | 0 | 0 | 2.00E+01 | 1.30 | 1.30 | 2.00E+01 | 4.79 | 99.998% |
| Buffer + | | 2 | 0 | 0 | 2.00E+01 | 1.30 | | | | |
| 2000 | | 3 | 0 | 0 | 2.00E+01 | 1.30 | | | | |
| ppm AO | | | | | | | | | | |
| 9 - AA | 4 | 1 | 0 | 0 | 2.00E+01 | 1.30 | 1.30 | 2.00E+01 | 4.79 | 99.998% |
| Buffer + | | 2 | 0 | 0 | 2.00E+01 | 1.30 | | | | |
| 1000 | | 3 | 0 | 0 | 2.00E+01 | 1.30 | | | | |
| ppm AO + | | | | | | | | | | |
| EtOH | | | | | | | | | | |
| 10 - AA | 5 | 1 | 0 | 0 | 2.00E+01 | 1.30 | 1.30 | 2.00E+01 | 4.79 | 99.998% |
| Buffer + | | | | | | | | | | |
| 1000 | | | | | | | | | | |
| ppm AO + | | | | | | | | | | |
| EtOH | | | | | | | | | | |

The results in Table 11 show that the acetic acid (AA) compositions alone in Samples 1-2 reduce 99% of the bacteria in both pH ranges achieving a 2-log reduction. The addition of 200 ppm active amine oxide kills 99.99% (4-log reduction) and by 1000 ppm or greater no bacterial colonies grew after plating. The Samples 5-10 having at least 1000 ppm active amine oxide results show greater than 4-log reductions in Table 11, however the results are more significant than that as they are compared to the control in Samples 1-2 with no amine oxide present. The results show that the presence of at least 200 ppm active amine oxide achieves antimicrobial efficacy of 4-log reduction with wipe applications, and based on the results herein a lower ppm threshold of amine oxide such as 100 ppm is further expected to achieve the 4-log reduction.

### Example 5

Additional testing of the antimicrobial composition in Table 12 (with and without ethanol; when ethanol was removed it was replaced with water) was conducted to compare drying of the formulations in comparing to a QAC based wipe and QAC based spray product. The test procedure included spraying two sprays (manual) onto a hard bench surface followed by immediate wiping with a dry polyester wipe substrate and thereafter measuring the time for drying of the composition on the surface.

TABLE 12

| | Base Formula |
|---|---|
| DI water | 89.6% |
| Ethanol | 10% |
| Barlox 12 | 0.3% |
| Acetic Acid | 0.1% |
| Total | 100% |

The results showed that the test compositions with and without ethanol provided acceptable drying time of less than 60 seconds, which is equivalent to the drying time of the QAC based wipe and QAC based spray product. There was an improved drying time with the ethanol drying agent in the composition shown in Table 12.

### Example 6

Additional testing of preferred amine oxides having an alkyl group C8-C16, or preferably an alkyl group C12-C16, was completed to analyze the pH of use solutions for use across various water types. Testing of the preferred amine oxides showed use pH preferred in the range of 4 to 5 regardless of water type to achieve biocidal efficacy and show the additional synergistic efficacy with amine oxide as summarized in Table 13 for both food contact sanitizing (FCS) and non-food contact sanitizing (NFCS), with the sanitizing efficacy against required bacteria as summarized in Table 14 (FCS) and Table 15 (NFCS).

TABLE 13

| | | | pH | pH |
|---|---|---|---|---|
| | Antimicrobial | Antimicrobial | (5 Grain | (17 Grain |
| Ingredient | Composition 8 | Composition 9 | water) | water) |
| Barlox 12 (30%) | 24-26 | 28-30 | | |
| Acetic acid | 24-26 | 24-26 | | |
| Octanoic acid | 0.5-1 | 0.5-1 | | |
| Sodium hydroxide (50%) | 4-5 | 4-5 | | |
| DI water | Remainder | Remainder | | |
| Total | 100 | 100 | | |
| FCS Use Concentration | | 0.2% wt. | | |
| ppm Amine oxide | 150 | 176 | 4.53 | 5.10 |
| NFCS Use Concentration | | 0.8% wt. | | |
| ppm Amine oxide | 600 | 700 | 4.16 | 4.36 |

TABLE 14
(FCS).

| | Test Sample (0.2% | Exposure | Log |
|---|---|---|---|
| Test organism | w/w in 500 ppm HW) | Temp | Reduction |
| S.aureus (ATCC 6538) | Composition 8 | 25° C. | 6.67 |
| | Composition 9 | | 6.50 |
| E.coli (ATCC 11229) | Composition 8 | | 6.98 |
| | Composition 9 | | 6.72 |
| Listeria monocytogenes | Composition 8 | 25° C. | 6.59 |
| | Composition 9 | | 6.59 |
| Salmonella enterica | Composition 8 | | 7.11 |
| | Composition 9 | | 7.11 |
| E.coli O157:H7 | Composition 8 | | 7.09 |
| | Composition 9 | | 7.09 |
| Cronobacter sakazakii | Composition 8 | | 6.14 |
| | Composition 9 | | 6.70 |

TABLE 15
(NFCS).

| | | Log Reduction | Log Reduction |
|---|---|---|---|
| | Contact | Staphylococcus aureus | Klebsiella aerogenes |
| Composition | Time | (ATCC 6538) | (ATCC 13048) |
| Composition 8 | 1 min | 3.21 | 4.68 |
| | 2 min | 3.48 | |
| | 5 min | 4.00 | |
| Composition 9 | 1 min | 2.18 | |
| | 2 min | 3.48 | |
| | 5 min | 3.87 | |

### Example 7

Additional testing of the foaming efficacy of Composition 9 described in Table 13 compared to a commercially available quaternary ammonium based foaming sanitizer for open food plant cleaning for foaming sanitizing. This method details a general approach to application of chemical foaming solutions to vertical surfaces—coupons or mounted coupons for example—followed by timed observation of vertical flow, foam character, foam volume, percent surface coverage, etc. Each of the compositions were sprayed onto a stainless steel wall surface and allowed to sit for 3 minutes. The ability of the foaming compositions to remain on the surfaces were evaluated and tracked by photographs for observational assessments. The comparison showed adequate performance (based on feedback of two technical sales associates and multiple researchers) of both the benchmark product and the amine oxide formulation in cling, stability, foam character, for foaming sanitizing products, where a balance of cling and dissipation is desirable.

### Example 8

Additional testing of the foaming efficacy of Composition 9 described in Table 13 was conducted on a floor surface as a floor foaming sanitizer. The composition was tested at a NFCS level of 0.8%. The testing used customer doorway foaming equipment and a similar regulated water and air flow. This equipment includes a controlled product use-solution and air supply pumped to a blend point, through a static mixer for foam generation, and a supply pipe of this foam to another spray nozzle on the floor. The comparison showed adequate performance (based on feedback of two technical sales associates and multiple researchers) of both the benchmark product and the amine oxide formulation for foam volume, stability, character.

### Example 9

Additional testing of an alkane derivative (coco amide) was evaluated for antimicrobial efficacy for use in the acidic antimicrobial composition. The evaluated composition was Composition 9 with the amine oxide replaced by coco amide amine oxide as described herein. The cocamidopropylamine oxide having the following structure was evaluated

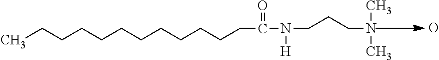 [SMILES: CCCCCCCCCCCCC(=O)NCCCN(C)C ; O]

The antimicrobial efficacy is shown in Table 16 for food contacting sanitizing resulting in a lack of sufficient antimicrobial efficacy compared to the amine oxides described for use in the antimicrobial acidic compositions. Without being limited to a particular mechanism of action, the evaluated composition with the coco amide amine oxide lacks sufficient surface activity, adherence, and penetration of bacterial surfaces.

TABLE 16

| | | Log Reduction | Log Reduction |
|---|---|---|---|
| | | E. Coli | S. aureus |
| Concentration | pH | (ATCC 11229) | (ATCC 6538) |
| 500 ppm | 4.0 | 1.65 | 3.37 |
| 500 ppm | 4.5 | 1.65 | 2.89 |
| 500 ppm | 5.0 | 1.65 | 2.17 |
| 500 ppm | 5.5 | 1.65 | 1.40 |

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims.

Any reference to accompanying drawings which form a part hereof, are shown, by way of illustration only. It is understood that other embodiments may be utilized, and structural changes may be made without departing from the scope of the present disclosure.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A method of use for providing surface cleaning, sanitizing and/or disinfecting comprising:
(a) contacting a surface in need of cleaning, sanitizing and/or disinfecting with an acidic antimicrobial composition comprising:
(i) an alkyl amine oxide according to the structure: 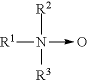
wherein R₁, R₂, and R₃ are independently selected from saturated or unsaturated and straight or branched alkyl groups or aromatic groups having from 1-24 carbons;
(ii) an acidulant comprising an inorganic acid, organic acid, or a combination thereof;
(iii) optionally a drying agent comprising an alcohol; and
(iv) water;
(b) wherein the acidic antimicrobial composition achieves at least a 1-log microbial reduction or at least a 3-log microbial reduction in 5 minutes or less in an in vitro assay;
wherein the pH of the use solution of the acidic antimicrobial composition is between about 3.5 to about 5.5, or wherein the pH of the RTU acidic antimicrobial composition is between about 4 to about 5.5.

2. The method of claim 1, wherein the alkyl amine oxide with R¹ is a C8-C16 alkyl group, or C12-C16 alkyl group, and R² and R³ are both CH₃.

3. The method of claim 1, wherein the amine oxide is (a) an alkyl dimethyl amine oxide, (b) an octyl, decyl, dodecyl, isododecyl or (c) a dimethyl amine oxide that is a lauryl dimethyl amine oxide, myristyl dimethyl amine oxide, palmitic dimethyl amine oxide, or a combination thereof, and/or wherein the acidulant comprises a carboxylic acid, polycarboxylic acid, or a salt thereof, and/or wherein the drying agent comprises methanol, ethanol, propanol, isopropanol, butanol, isobutanol, 2-butoxyethanol, 1-decanol, benzyl alcohol, or combinations thereof.

4. (canceled)

5. (canceled)

6. The method of claim 1, wherein the amine oxide comprises from about 8 wt-% to about 50 wt-% of the composition, and/or wherein the acidulent comprises from about 1 wt-% to about 20 wt-% of the composition.

7. The method of claim 1, wherein the acidic antimicrobial composition further comprises a buffer, a defoaming agent, a propellant, an additional antimicrobial active, fragrance, dye, or combination thereof.

8. The method of claim 1, wherein the contacting is wiping a surface with a substrate either saturated with or sprayed with a ready-to-use (RTU) dilution of the acidic antimicrobial composition, and wherein the amine oxide comprises from about 0.01 wt-% to about 10 wt-%, and/or wherein the drying agent comprises from about 1 wt-% to about 15 wt-%, and/or wherein the acidulent comprises from about 0.1 wt-% to about 10 wt-% of the RTU composition.

9. (canceled)

10. The method of claim 1, wherein the acidic antimicrobial composition
(a) has at least about 75%, at least about 80%, at least about 85%, or at least about 90% reduction in the concentration of quaternary ammonium compounds, oxidizing chemistries, and/or disinfectants compared to an antimicrobial composition that does not include the alkyl amine oxide and the acidulent; or
(b) has less than about 20 wt-%, 10 wt-%, 5 wt-% or 1 wt-% of quaternary ammonium compounds, oxidizing chemistries, and/or disinfectants in the acidic antimicrobial composition;
(c) has less than about 1 wt-%, 0.5 wt-%, 0.1 wt-% of quaternary ammonium compounds, oxidizing chemistries, and/or disinfectants in the RTU of the acidic antimicrobial composition; or
(d) is substantially free or is free of quaternary ammonium compounds, anionic surfactants, oxidizing chemistries, disinfectants, and/or N-alkylpyrrolidones or derivatives thereof.

11. (canceled)

12. The method of claim 1, wherein the method achieves a 3-log microbial reduction in 5 minutes or less in an in vitro assay against Klebsiella aerogenes or Staphylococcus aureus for non-food contact surface sanitizing according to ASTM E1153, or wherein the method achieves a 5-log microbial reduction in 30 seconds or less in an in vitro assay against Staphylococcus aureus and/or Escherichia coli for food contact surface sanitizing according to AOAC Method 960.09, or wherein the method achieves at least a 1-log reduction of a non-pathogenic organism according to AOAC Method 960.09, and/or wherein the method provides disinfection of a treated surface, or wherein the method achieves at least a 3-log order reduction of viruses on a surface or substrate within 5 minutes in an in vitro assay according to one of the following standards: ASTM E1053 Standard Test Method for Efficacy of Virucidal Agents Intended for Inanimate Environmental Surfaces; EPA 810.2200; or EN 14476.

13. (canceled)

14. (canceled)

15. (canceled)

16. The method of claim 1, wherein the surface is a hard surface and comprises a metal in need of low corrosivity.

17. The method of claim 16, wherein the hard surface is located within a food or beverage manufacturing facility or on farm premises, or wherein the hard surface located within a food or beverage manufacturing facility is a processing surface, a food-preparation surface, a surface in a restaurant, a surface in a grocery store, a household surface, a drive-thru surface, and/or a hard surface comprising food soils, and wherein the surface located on farm premises is a device, apparatus, machine, pipe, hose, conduit, tube, nozzle, sprayer, carousel, shaft, cavity, container, vat, or rail used in a farm process or production of a farm product.

18. The method of claim 1, wherein the surface is a soft and/or porous surface.

19. The method of claim 1, wherein the method further comprises rinsing the surface.

20. The method of claim 1, wherein the antimicrobial composition is a concentrate and the method further comprises a first step of generating a use solution of the antimicrobial composition before contacting the surface, and wherein the use solution is generated with a water source.

21. A concentrate or ready-to-use (RTU) acidic antimicrobial composition comprising:
(i) an alkyl amine oxide according to the structure:
wherein R¹, R², and R³ are independently selected from saturated or unsaturated and straight or branched alkyl groups or aromatic groups having from 1-24 carbons;
(ii) an acidulant comprising an inorganic acid, organic acid, or a combination thereof;
(iii) optionally a drying agent comprising an alcohol; and
(iv) water,
wherein the pH of the concentrate composition is between about 3.5 to about 5.5, or wherein the pH of the RTU acidic antimicrobial composition is between about 4 to about 5.5, and
wherein the RTU acidic antimicrobial composition is optionally saturated on a wipe substrate.

22. The composition of claim 21, wherein the alkyl amine oxide is a dimethyl alkyl amine oxide wherein R¹ is a C8-C16 alkyl group and R² and R³ are both CH₃.

23. The composition of claim 21, wherein
the amine oxide is (a) an alkyl dimethyl amine oxide, (b) an octyl, decyl, dodecyl, isododecyl, or (c) a dimethyl amine oxide that is a lauryl dimethyl amine oxide, myristyl dimethyl amine oxide, palmitic dimethyl amine oxide, or combinations thereof, and/or wherein the acidulant comprises a carboxylic acid, polycarboxylic acid or salt thereof, and/or wherein the drying agent comprises methanol, ethanol, propanol, isopropanol, butanol, isobutanol, 2butoxyethanol, 1decanol, benzyl alcohol, or combinations thereof.

24. (canceled)

25. (canceled)

26. The composition of claim 21, wherein the amine oxide comprises from about 8 wt-% to about 50 wt-% of the concentrate composition, and wherein the acidulant comprises from about 1 wt-% to about 20 wt-% of the concentrate composition, or wherein the amine oxide comprises from about 0.01 wt-% to about 10 wt-% of the RTU composition,
optionally wherein when the drying agent is present it comprises from about 1 wt-% to about 15 wt-%, and
wherein the acidulant comprises from about 0.1 wt-% to about 10 wt-% of the RTU composition.

27. The composition of claim 21, further comprising a defoaming agent, propellant, additional antimicrobial active, or a combination thereof.

28. The composition of claim 21, wherein the antimicrobial composition
(a) has at least about 75%, at least about 80%, at least about 85%, or at least about 90% reduction in the concentration of quaternary ammonium compounds, oxidizing chemistries, and disinfectants compared to an antimicrobial composition that does not include the alkyl amine oxide and the acidulant; or
(b) has less than about 20 wt-%, 10 wt-%, 5 wt-% or 1 wt-% of quaternary ammonium compounds, oxidizing chemistries, and/or disinfectants in the acidic antimicrobial composition; or
(c) has less than about 1 wt-%, 0.5 wt-%, or 0.1 wt-% of quaternary ammonium compounds, oxidizing chemistries, and disinfectants in the RTU antimicrobial composition; or
(d) wherein the composition is substantially free of or free of quaternary ammonium compounds, anionic surfactants, oxidizing chemistries, disinfectants, and/or Nalkylpyrrolidones or derivatives thereof.

29. (canceled)

30. (canceled)

31. The composition of claim 21, wherein the composition is a non-oxidizing, low-toxicity and low-corrosivity composition.
